(19) United States
(12) Patent Application Publication
(10) Pub. No.: US 2021/0304285 A1
(43) Pub. Date: Sep. 30, 2021

(54) SYSTEMS AND METHODS FOR UTILIZING MACHINE LEARNING MODELS TO GENERATE CONTENT PACKAGE RECOMMENDATIONS FOR CURRENT AND PROSPECTIVE CUSTOMERS

(71) Applicant: Verizon Patent and Licensing Inc., Arlington, VA (US)

(72) Inventor: Kaiss K. ALAHMADY, Plano, TX (US)

(21) Appl. No.: 16/836,448

(22) Filed: Mar. 31, 2020

(51) Int. Cl. G06Q 30/06; G06N 20/20; G06Q 30/02

(52) U.S. Cl. CPC G06Q 30/0631; G06Q 30/0201; G06N 20/20

(57) ABSTRACT

A device may receive, from a user device, user data and a request associated with content, wherein the user data identifies an action of a user of the user device, a behavior of the user, or a feature associated with the user. The device may receive constraint data identifying one or more constraints associated with the content, and may process the request, the user data, and the constraint data, with machine learning models, to determine a response to the request, wherein the response to the request includes a recommended set of the content for the user, and wherein the machine learning models have been trained based on historical requests associated with the content, historical user data associated with other users of other user devices, historical constraint data, or historical content data associated with the content. The device may perform one or more actions based on the response.

### BACKGROUND

Recommendation systems are used in many applications to recommend products, services, movies, articles, and/or the like to customers. For example, content providers and/or websites provide suggestions or recommend features and services to customers, such as movies, articles, restaurants, places to visit, products to buy or rent, and/or the like. The recommendation systems generate these suggestions or recommended features and services. The recommendation systems generate recommendations based on past and/or current preferences of the customers in order to improve customer experience and/or a business outcome of a recommendation provider. For example, recommendations may include cross-selling products and/or services, upselling products and/or services, increasing customer loyalty, increasing advertisement revenue, and/or the like.

### BRIEF DESCRIPTION OF THE DRAWINGS

FIGS. 1A-1Y are diagrams of one or more example implementations described herein.

FIG. 2 is a diagram illustrating an example of training a machine learning model.

FIG. 3 is a diagram illustrating an example of applying a trained machine learning model to a new observation.

FIG. 4 is a diagram of an example environment in which systems and/or methods described herein may be implemented.

FIG. 5 is a diagram of example components of one or more devices of FIG. 2.

FIG. 6 is a flow chart of an example process for utilizing machine learning models to generate content package recommendations for current and prospective customers.

### DETAILED DESCRIPTION OF PREFERRED EMBODIMENTS

The following detailed description of example implementations refers to the accompanying drawings. The same reference numbers in different drawings may identify the same or similar elements.

Products and/or services that include multiple items that are sold as a package present challenges to both providers and customers of such products and/or services. An example of such products and/or services is television content. Television content may include multiple content items, such as linear programming channels, video-on-demand content, games, widgets, applications, and/or the like. For linear television programming, current recommendation systems may recommend content packages that include pre-existing lineups of possibly hundreds of television channels. However, such content packages fail to provide personalization at a content level. Furthermore, current recommendation systems are unable to learn customer preferences from actions of the customer regarding content and are unable to use the customer preferences across other content. Thus, current recommendation systems waste computing resources (e.g., processing resources, memory resources, and/or the like), communication resources, networking resources, and/or the like associated with determining incorrect recommendations of content, implementing the incorrect recommendations, correcting the incorrect recommendations if discovered, and/or the like.

Some implementations described herein provide a recommendation platform that utilizes machine learning models to generate content package recommendations for current and prospective customers. For example, the recommendation platform may receive, from a user device, user data and a request associated with content, where the user data may identify an action of a user of the user device, a behavior of the user, a feature associated with the user, and/or the like. The recommendation platform may receive constraint data identifying one or more constraints associated with the content, and may process the request, the user data, and the constraint data, with one or more machine learning models, to determine a response to the request. The response to the request may include a recommended set of the content for the user, and the one or more machine learning models may have been trained based on historical requests associated with the content, historical user data associated with other users of other user devices, historical constraint data, historical content data associated with the content, and/or the like. The recommendation platform may perform one or more actions based on the response to the request.

In this way, the recommendation platform utilizes machine learning models to generate content package recommendations for current and prospective customers. Unlike current techniques, the recommendation platform recommends, for a user, a larger grouping of content derived from a much smaller subset of content recommended for the user from the same larger set of content. At least one relationship exists between content, and the recommendation platform generates the larger set of content from a user selection of a recommended smaller subset of content. The recommendation platform updates one or more of the recommended smaller subsets of content with each user selection, the user selection being repeated until the larger grouping of content is personalized for the user. Thus, the recommendation platform conserves computing resources, communication resources, networking resources, and/or the like that would otherwise have been wasted in identifying incorrect recommendations of content, implementing the incorrect recommendations, correcting the incorrect recommendations if discovered, and/or the like.

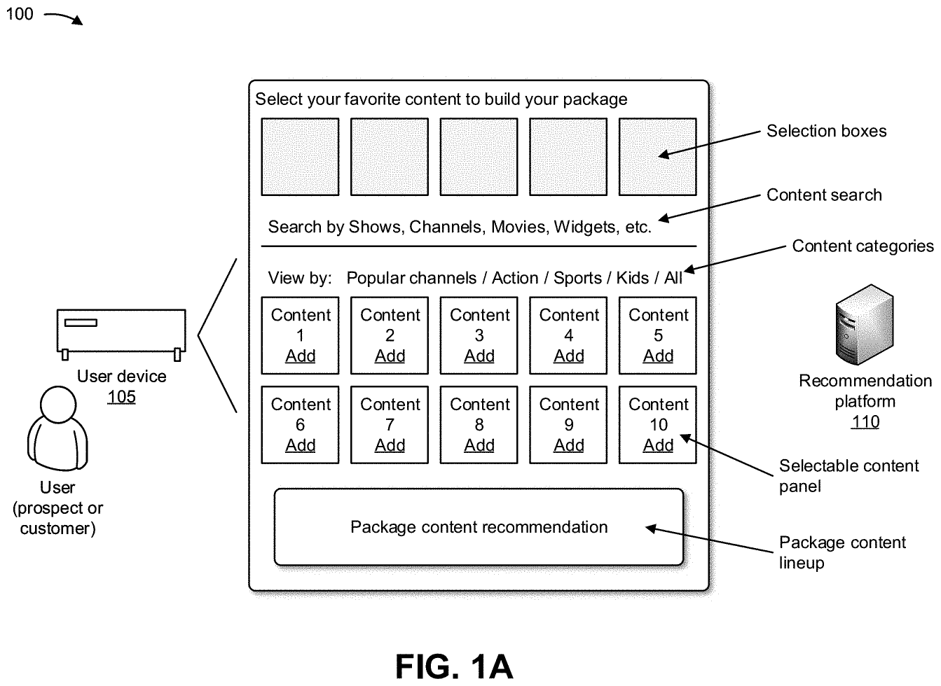

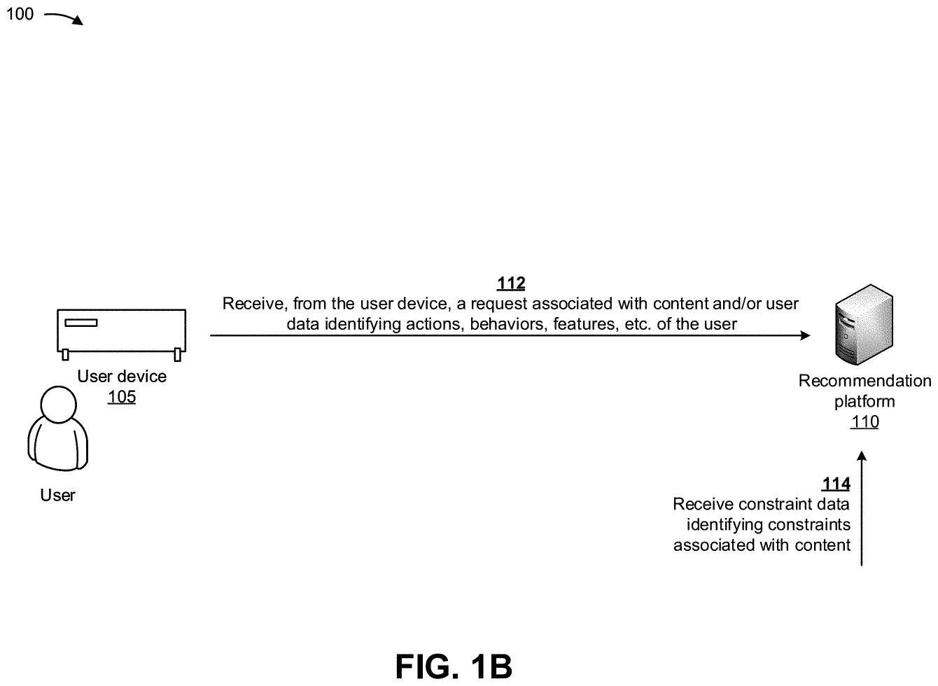

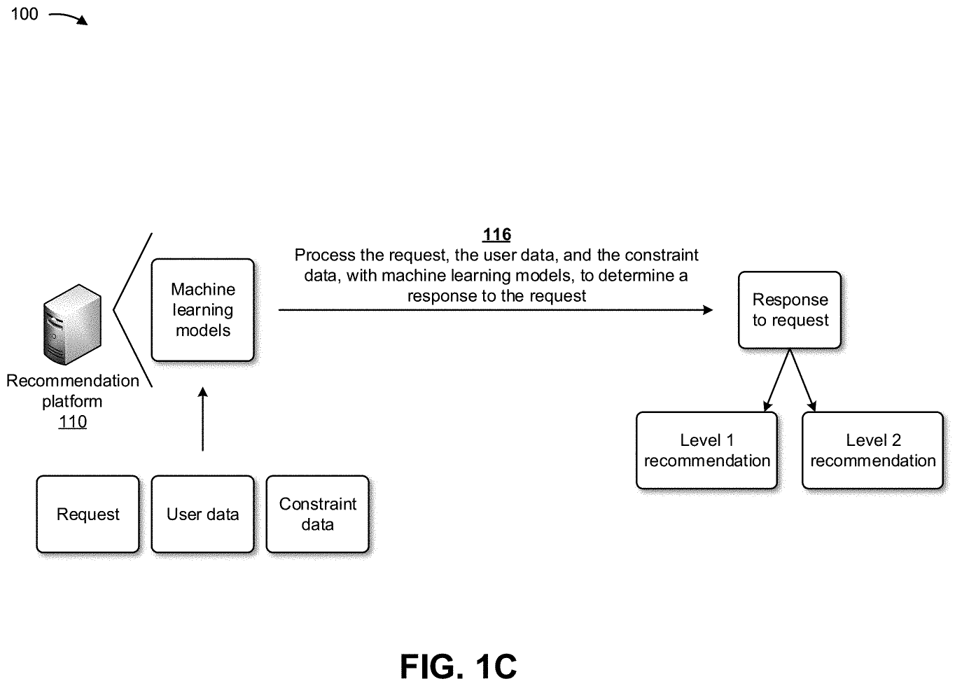

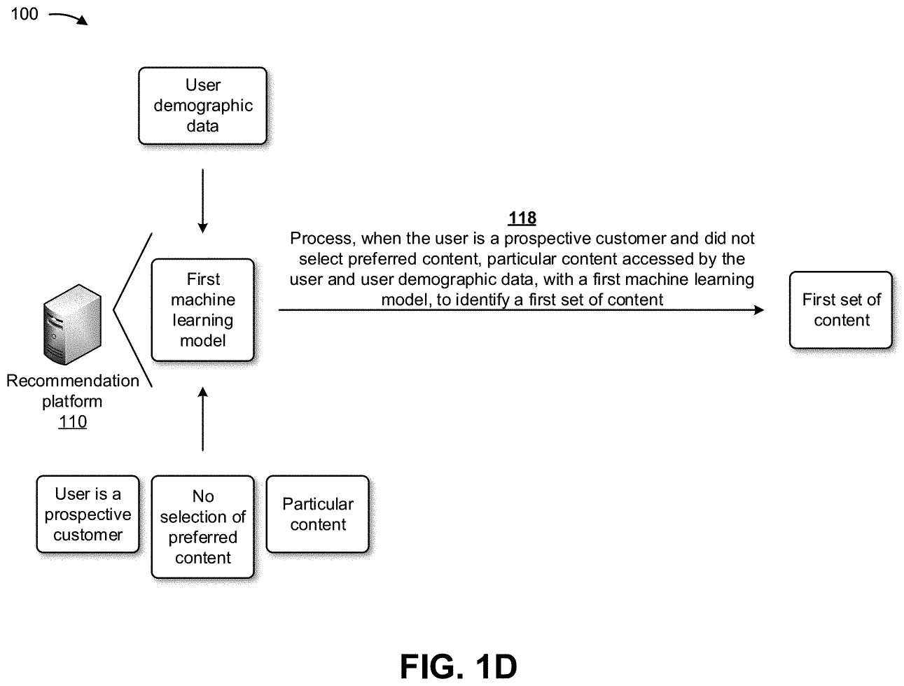

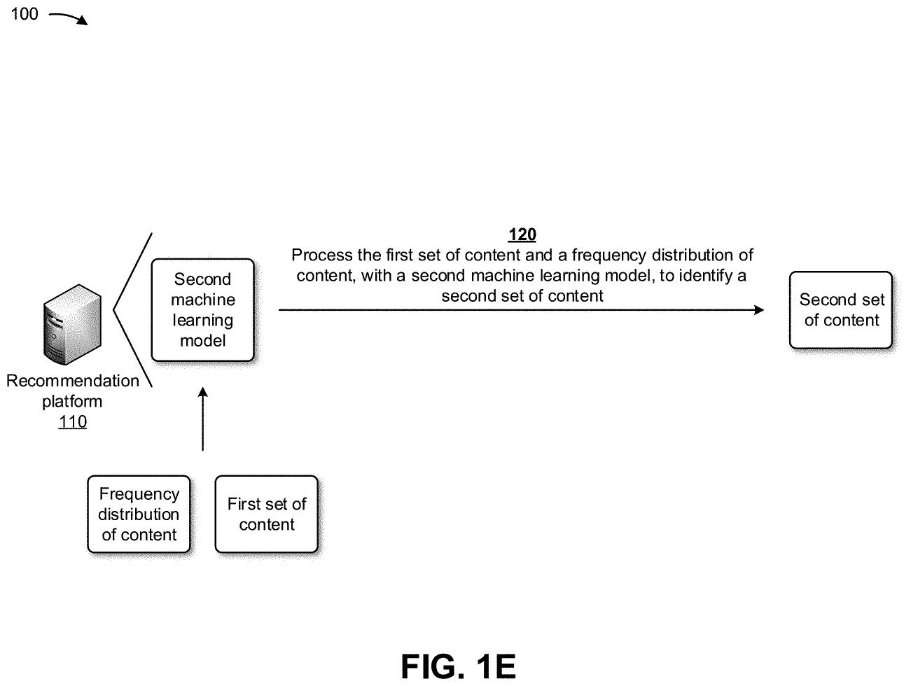

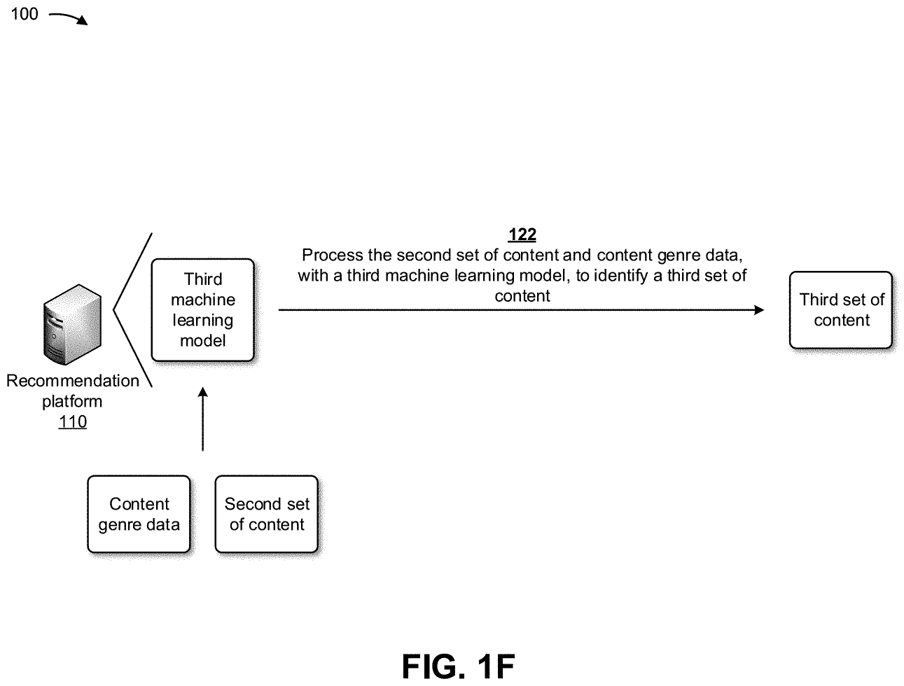

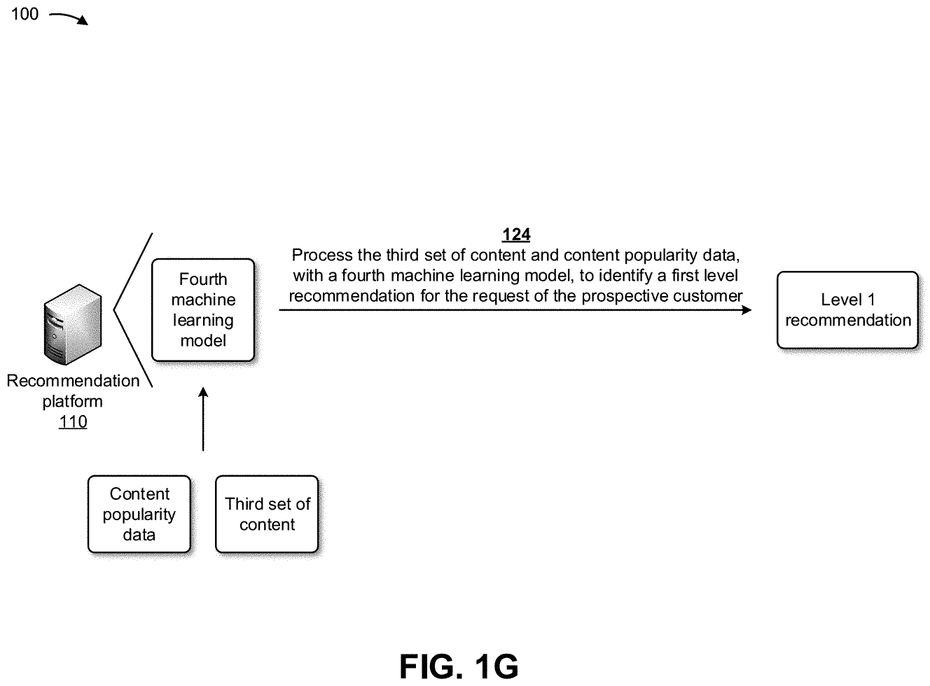

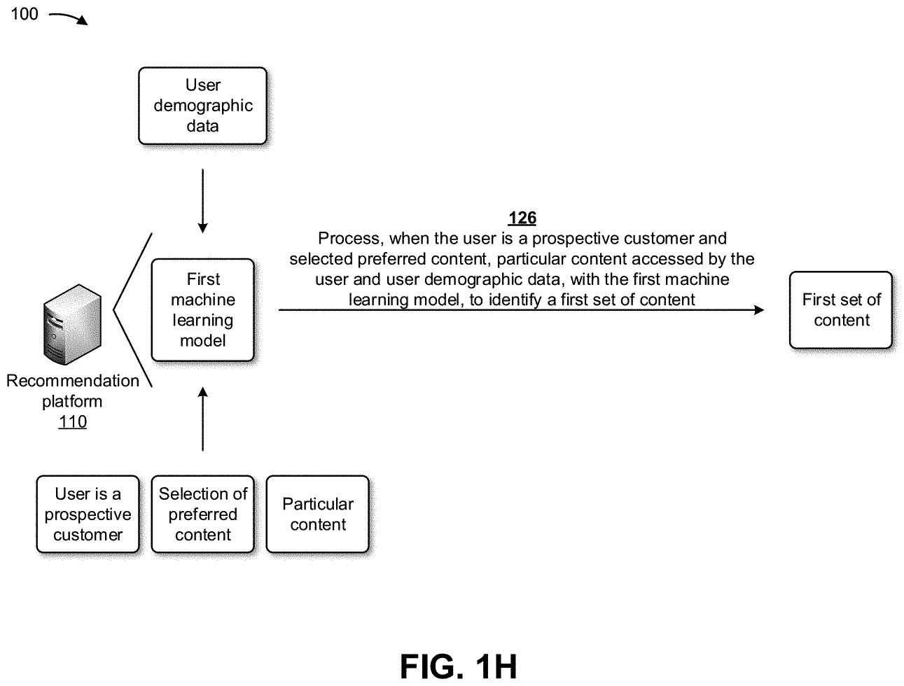

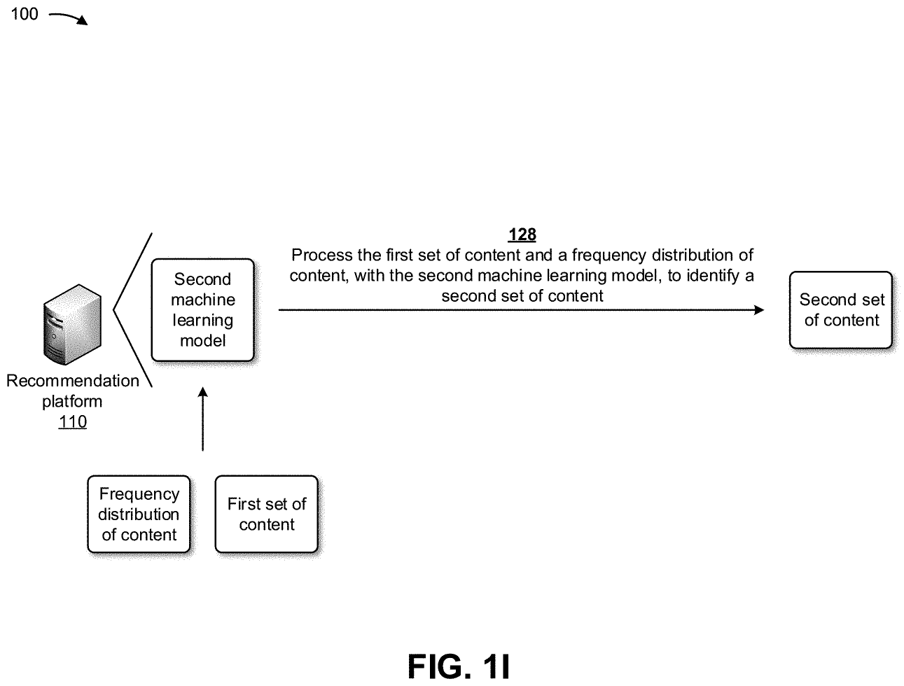

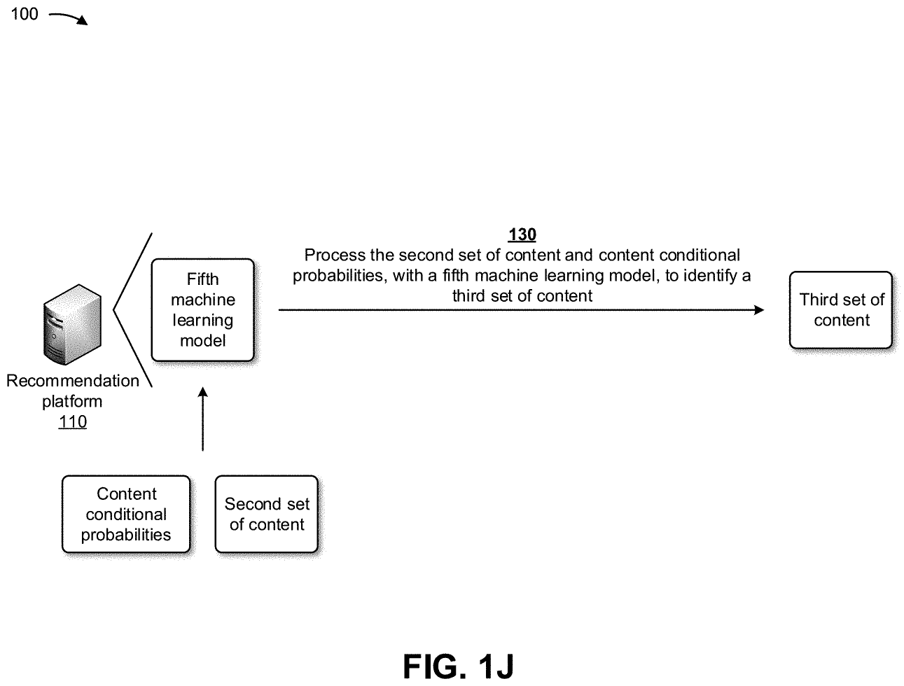

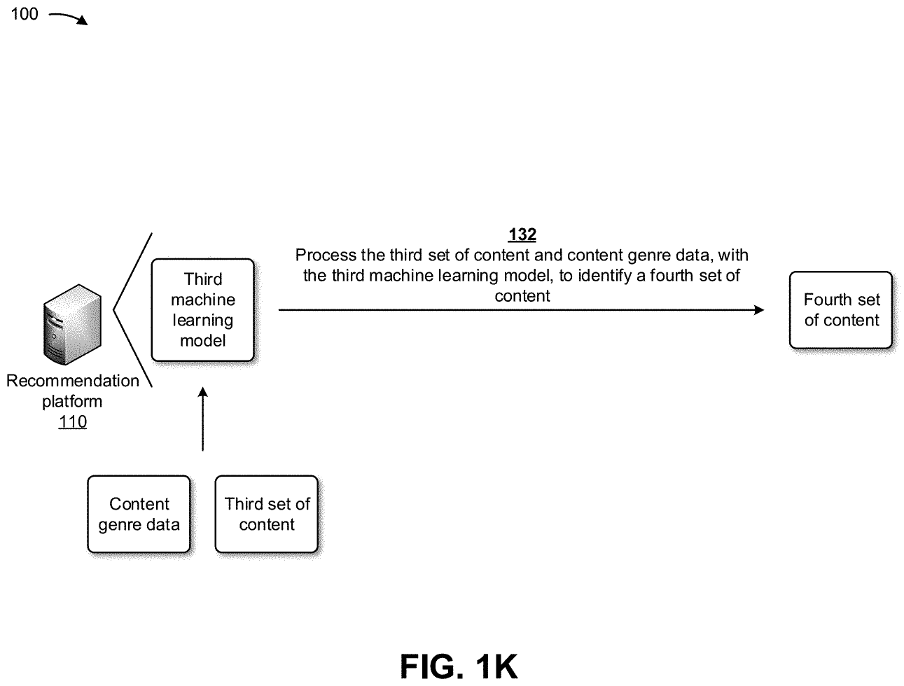

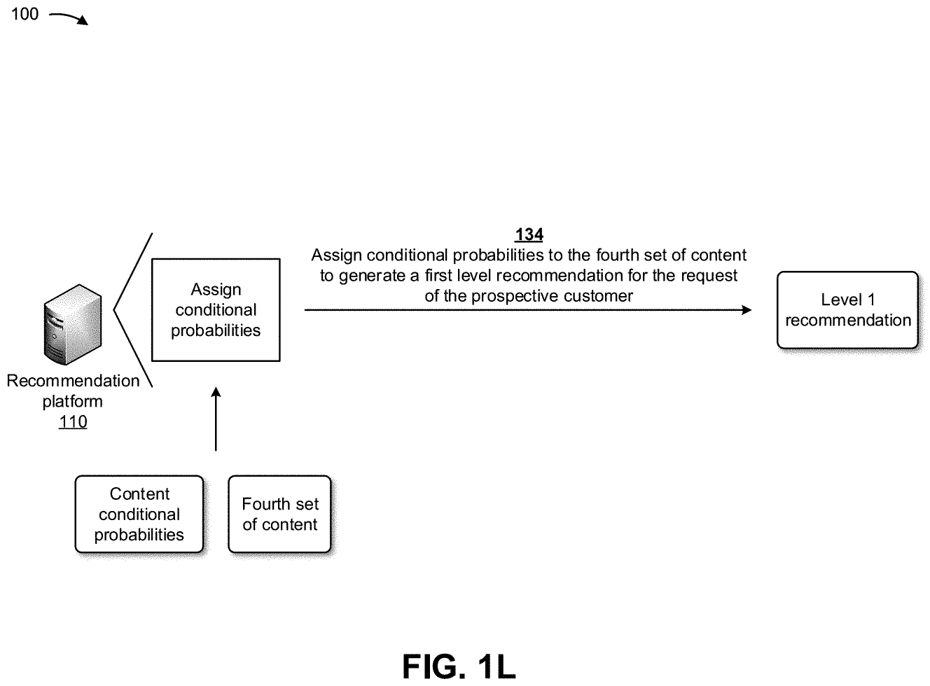

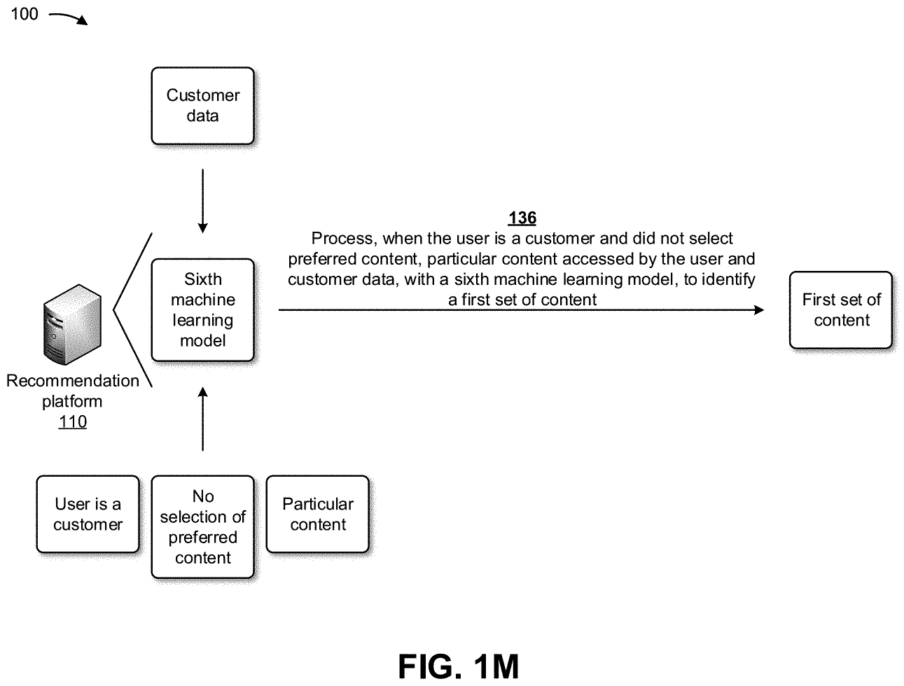

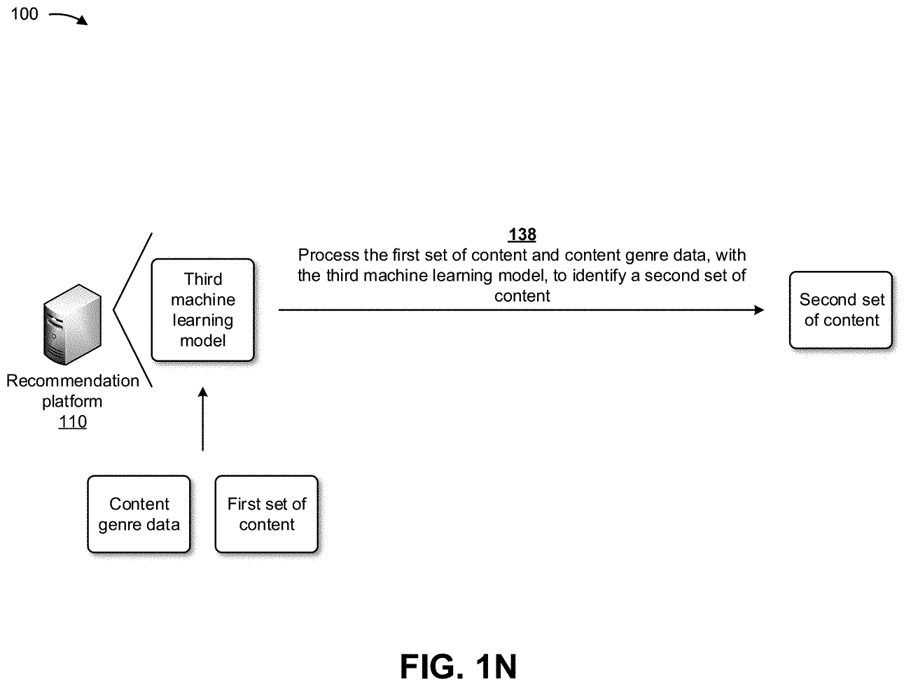

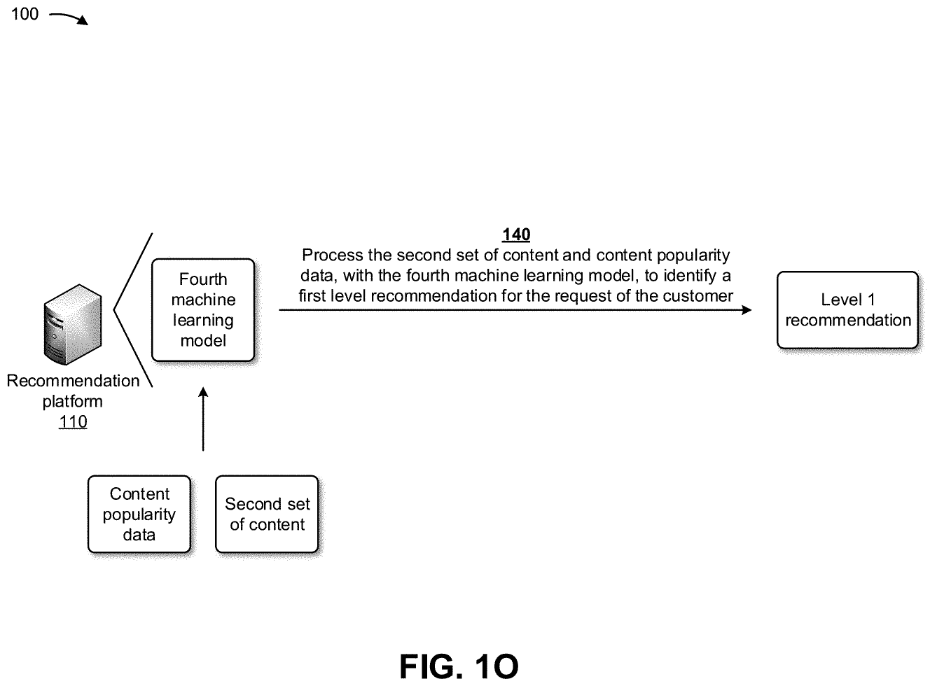

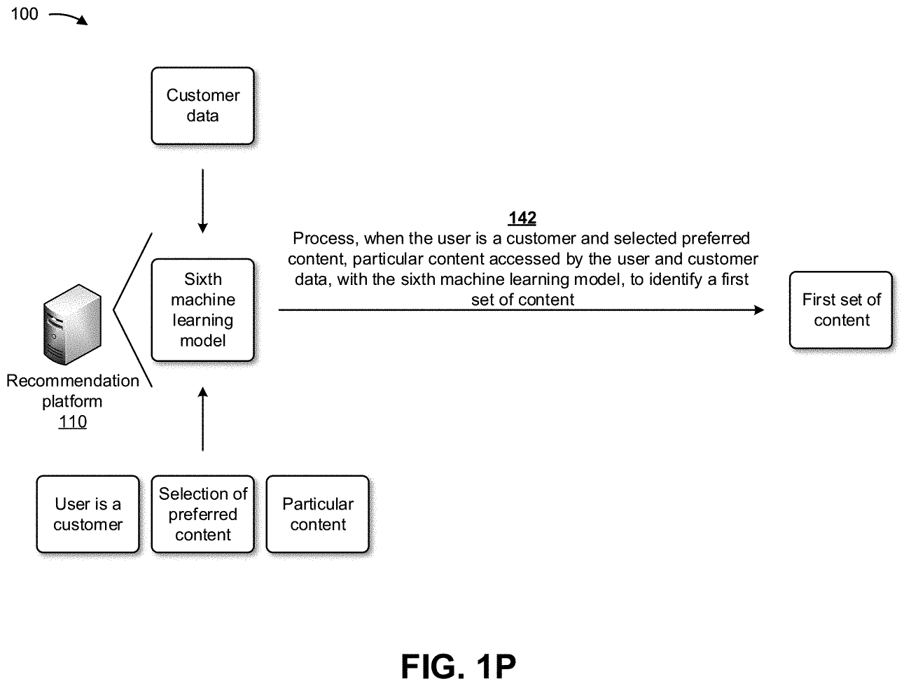

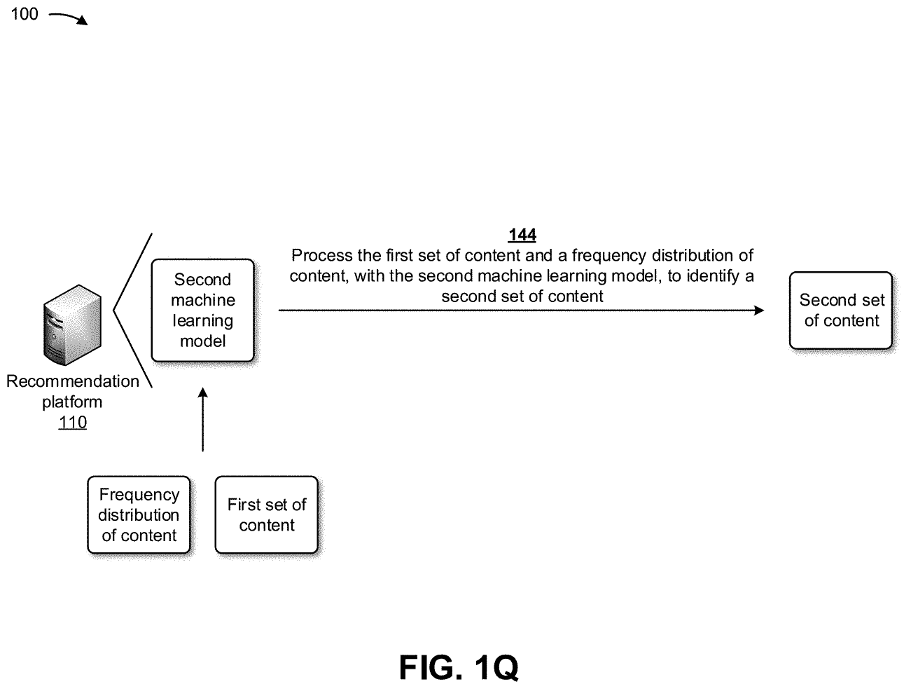

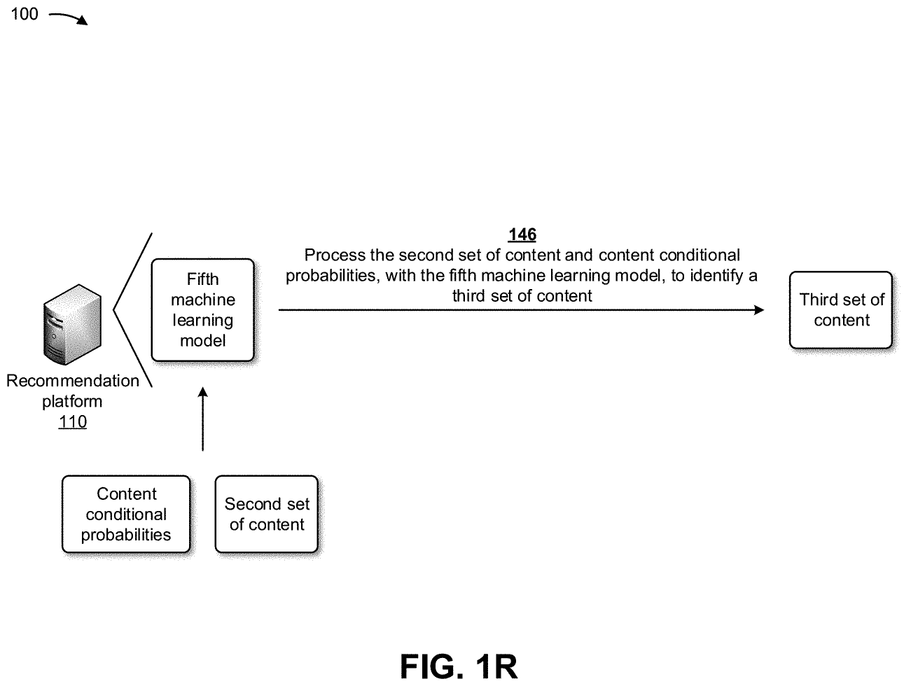

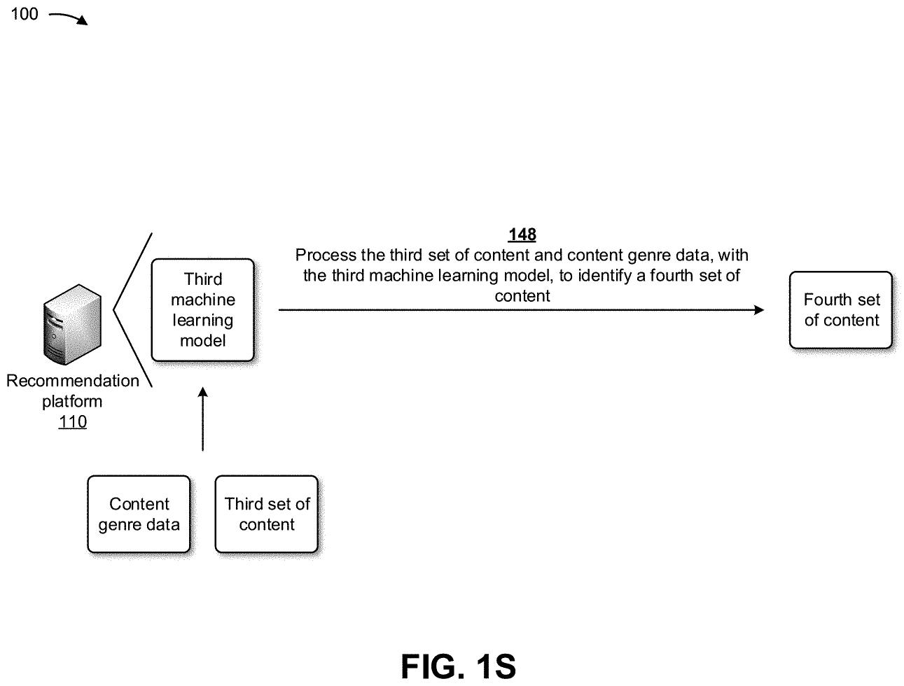

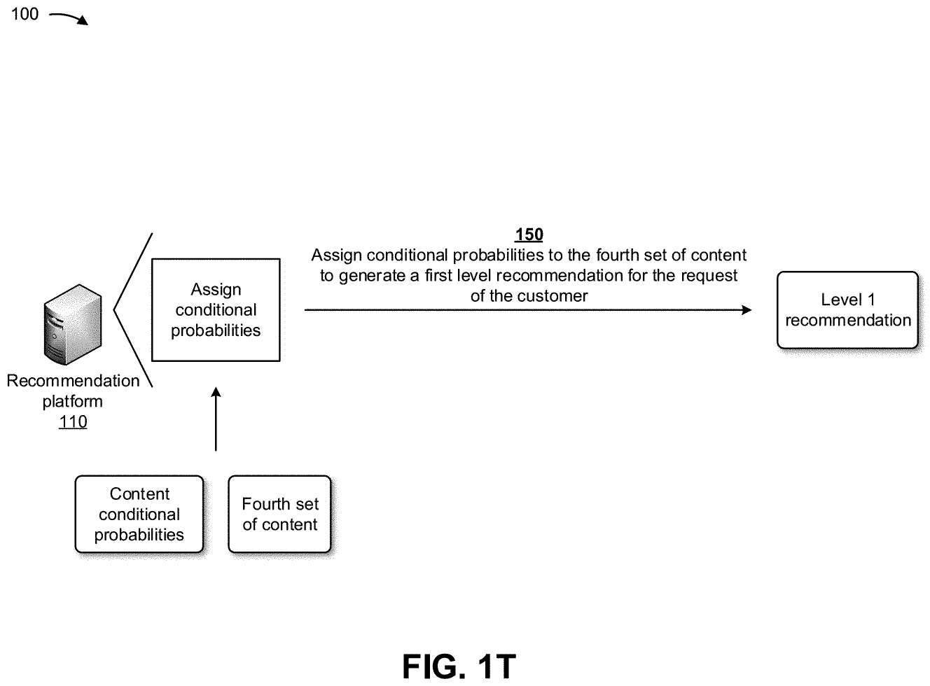

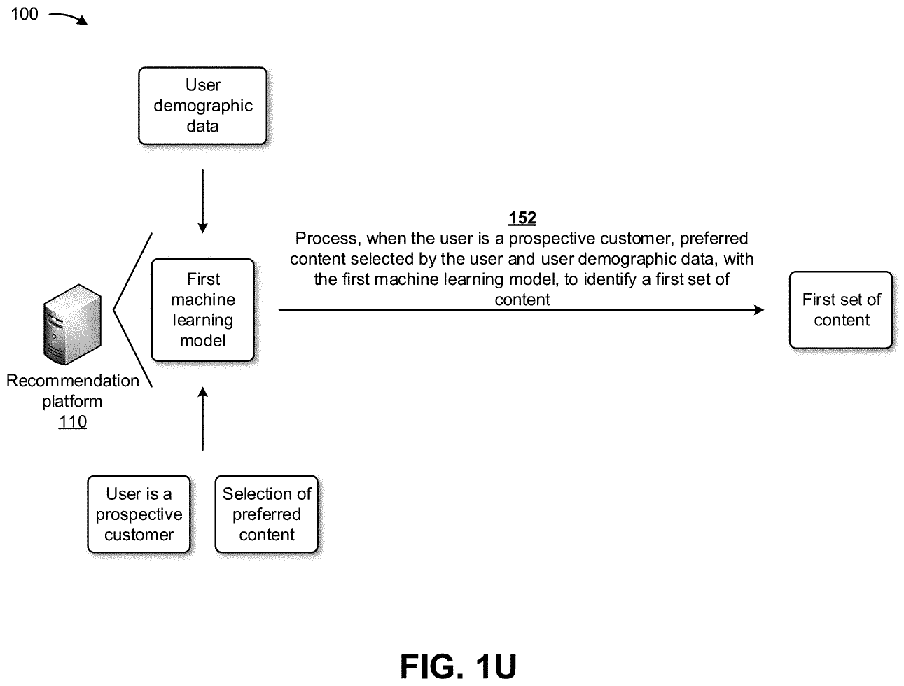

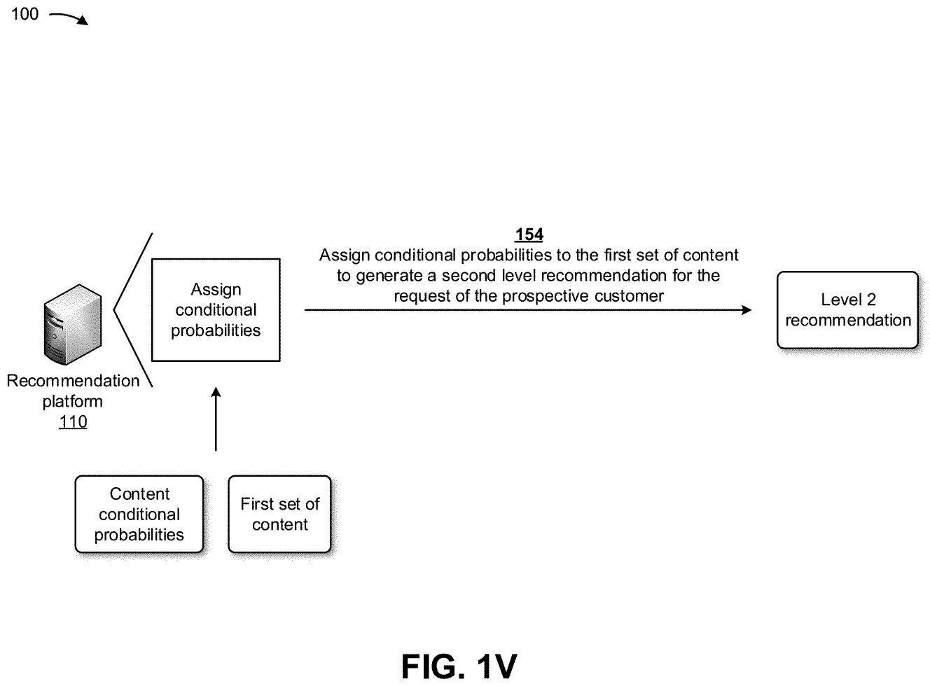

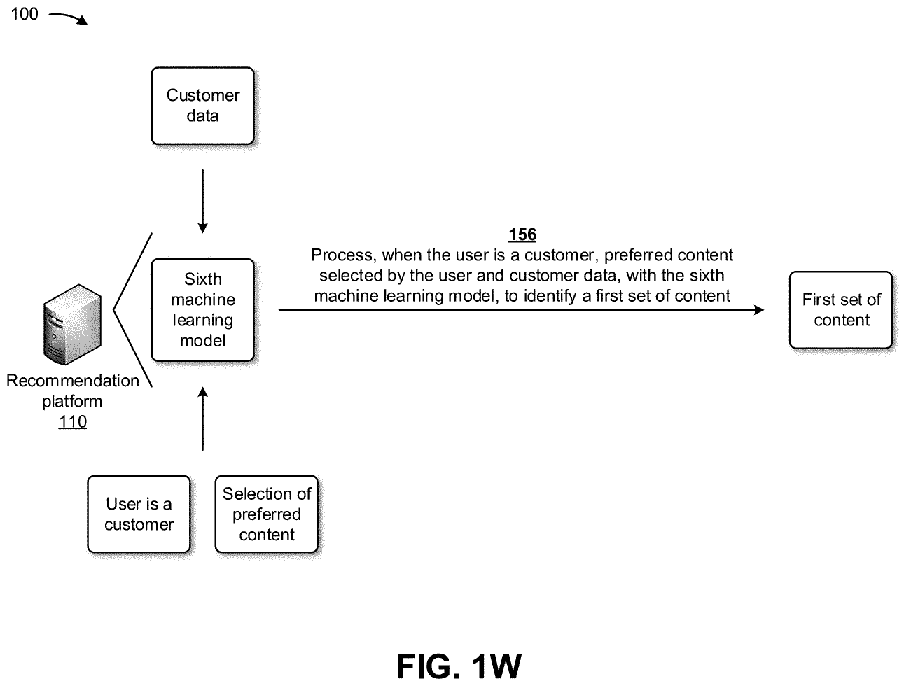

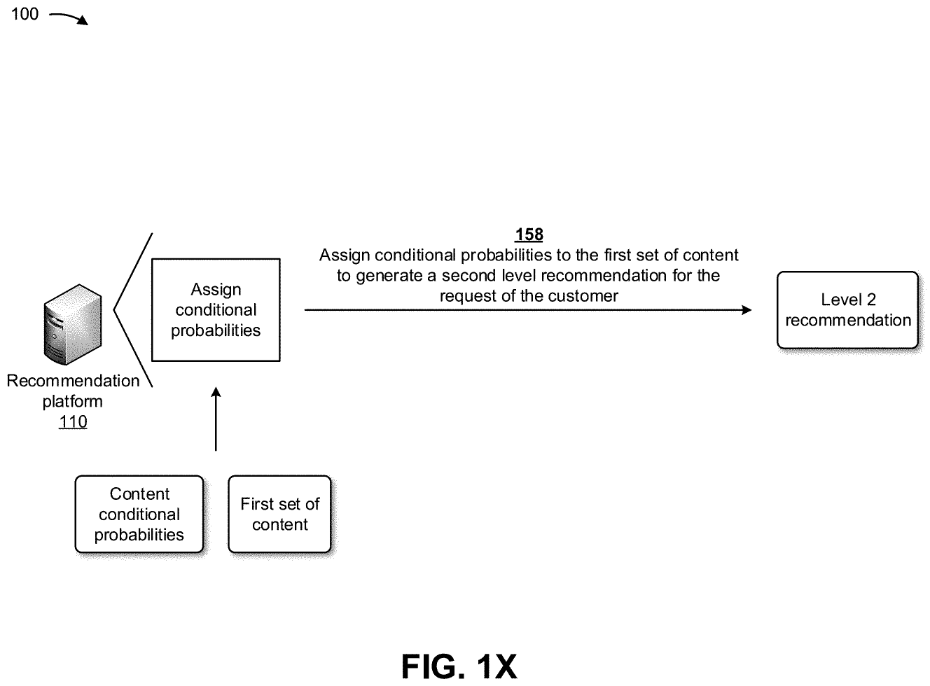

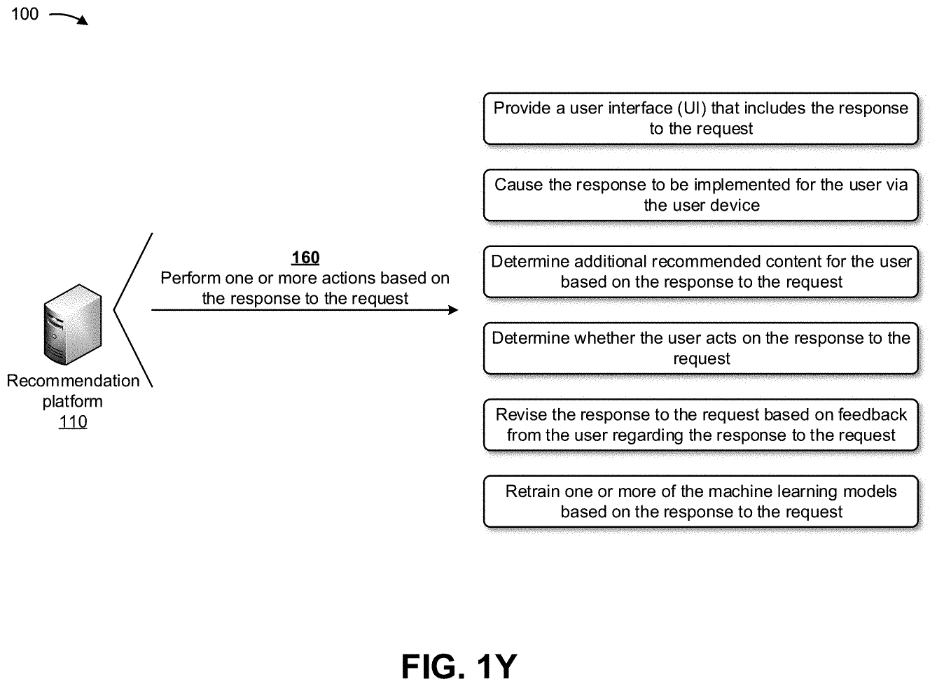

FIGS. 1A-1Y are diagrams of one or more example implementations 100 described herein. As shown in FIG. 1A, a user device 105 may be associated with a user (e.g., a customer and/or a prospective customer of an entity providing content) and a recommendation platform 110. User devices 105 may include mobile devices, computers, telephones, set-top boxes, and/or the like that the customers may utilize to interact with recommendation platform 110. Recommendation platform 110 may include a platform that utilizes machine learning models to generate content package recommendations for current and prospective customers, as described herein. The user may be a current purchaser, renter, subscriber, and/or the like of items (e.g., content, products, services, and/or the like) that may be recommended by recommendation platform 110, may be a previous purchaser, renter, subscriber, and/or the like of such items, may be a prospective purchaser, renter, subscriber, and/or the like of such items, and/or the like.

As further shown in FIG. 1A, user device 105 may be associated with a user interface via which the user can provide and receive information associated with selecting and determining content (e.g., linear programming channels, video-on-demand content, music content, games, widgets, and/or the like) to be provided to the user. For example, user device 105 may display a graphical user interface screen via a television, a computer, a mobile telephone, and/or the like, and the user may make selections and/or enter information via a remote control device, a keyboard, a touch-screen, and/or the like. As shown, the user interface may include a content search area for which the user may enter content to search (e.g., by shows, channels, and/or the like). As further shown, the user interface may include a selectable content panel from which the user can select preferred content (e.g., television channels). Content in the selectable content panel may be based on a default set of content, a content search or content categories selected by the user, content selected by the user, and/or the like. The user may enhance selection of the content by selecting content categories (e.g., popular channels, action, sports, kids, all channels, and/or the like) and/or based on information (e.g., a word or phrase indicative of the content of interest to the user, such as a show name, a show category (e.g., comedy), an actor's name, a channel name or number, and/or the like) entered into the content search area.

Selected content may be displayed in selection boxes. For example, the user may be allowed to select five preferred television channels, and the selected television channels may be displayed in five selection boxes. The user interface may further include a package content lineup area in which a package content recommendation may be displayed based on the user's preferred content selection and additional information, as described herein. For example, the package content recommendation may include a large quantity of television channels and/or other items of content which may be offered as a package to the user. Content in the selectable content panel and/or the package content lineup area may be based on a default set of content, a content search or content categories selected by the user, content selected by the user, and/or the like, and may be continually updated based on input by the user.

As shown in FIG. 1B, and by reference number 112, recommendation platform 110 may receive, from user devices 105 and over a time period, a request associated with content and/or user data identifying actions, behaviors, features, and/or the like of the user. In some implementations, the content may include one or more linear programming channels, video-on-demand content, music content, one or more games, one or more widgets (e.g., applications that provide local information, such as weather, based on geographical locations), one or more applications, and/or the like. The request may include data identifying particular content accessed by the user for a particular time period, may include the preferred content (e.g., the preferred television channels described above) selected by the user, may include other user information (e.g., information associated with a search performed by the user, a category selected by the user, and/or the like), and/or the like.

In some implementations, the request is associated with actions of the user. The actions of the user may include actions associated with access, contemplation, sampling, acquisition, consumption, and/or the like of content by the user. In some implementations, the request is associated with behaviors of the user. The behaviors of the user may include activities associated with purchases, uses, disposals, and/or the like of content, including emotional, mental, behavioral, and/or the like responses of the user that precede or follow the activities. In some implementations, the request is associated with features of the user. The features of the user may include demographic features of the user, such as a race, an ethnicity, a gender, an age, an education level, a profession, an occupation, an income level, a marital status, and/or the like of the user. For example, if recommendation platform 110 is associated with recommending video-on-demand (VOD) titles to customers, the actions, behaviors, and/or features of the customers may include time spent by the customers consuming VOD products; time spent by the customers on particular VOD titles or genres; quantities of views of particular VOD titles or genres by the customers; whether a VOD title was viewed in its entirety or partially viewed by the customers; whether a VOD title was contemplated (e.g., by reading a description or watching a trailer) by the customers; browsing behaviors and/or habits of the customers; browsing preferences of the customers; demographics of the customers; and/or the like.

Recommendation platform 110 may receive the user data directly from user device 105, may receive the user data from another system (e.g., that received the user data directly from user device 105, that extracted, compiled, generated, the user data based on data received from user device 105), and/or the like. Recommendation platform 110 may periodically receive the user data, may continuously receive the user data, may receive the user data based on a request, and/or the like. Recommendation platform 110 may store the user data in a data structure (e.g., a database, a table, a list, and/or the like) associated with recommendation platform 110.

As further shown in FIG. 1B, and by reference number 114, recommendation platform 110 may receive constraint data identifying constraints associated with the content. The constraints may include channel combination constraints, a number of channels to recommend, financial limits and/or optimization constraints on the content, legal constraints on the content, dynamic personalization of the content, marketing objectives for the content, and/or the like. A constraint may be associated with one or more measures of interest that create co-existence requirements between two or more of items of content. The measure of interest may be driven by contractual, financial, or marketing reasons, from combinations of contractual, financial, or marketing reasons, and/or the like. A contractual reason may exist if a supplier of two or more items requires that the items be packaged only together. For example, in a television linear programming scenario, a single channel may not be included in a lineup package without at least one or more other channels being included. A financial reason may arise from a cost of packaging many possible combinations of content, wherein some of the combinations are cheaper than others. For example, in the television linear programming scenario, a package of a combination of one-hundred channels may be cheaper than a package of another combination of one-hundred channels. Additionally, or alternatively, a constraint may be associated with whether the user is a current customer, a past customer, or prospective customer.

As shown in FIG. 1C, and by reference number 116, recommendation platform 110 may process the request, the user data, and the constraint data, with machine learning models, to determine a response to the request. The response to the request may include a recommended set of the content for the user (e.g., a quantity of local channels that include local programs, regional programs, video-on-demand programs, widgets, applications, music, sets of channels, and/or the like). For example, the response to the request may include a first level recommendation that identifies a first set of channels and a second level recommendation that identifies a second set of channels with more channels than channels provided in the first set of channels. The second set of channels may include one or more of the channels included by the first set of channels. For example, in addition to the first set of channels, the second set of channels may include local channels, regional channels, tagalong channels (e.g., a channel that must also be provided when a selected channel is provided) associated with the one or more of the first set of channels, a lineup of a large quantity of linear programming channels, tagalong channels associated with one or more of the linear programming channels in the lineup, and/or the like.

The machine learning models may include clustering models, random forest models, decision tree models, k-means models, density-based spatial clustering of applications with noise (DBSCAN) models, expectation maximization (EM) models, clustering using a Gaussian mixture models (GMM), and/or the like. The machine learning models may include clustering models that perform cluster analysis to group sets of objects in such a way that objects in a same group (i.e., a same cluster) are more similar (in some sense) to each other than to objects in other groups (i.e., other clusters).

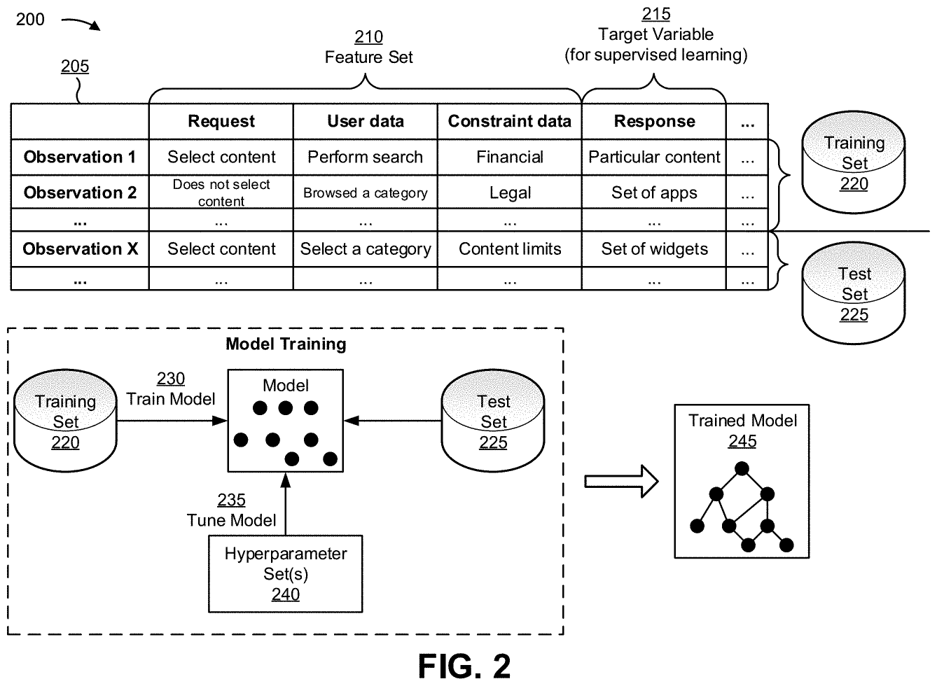

The one or more machine learning models may have been trained based on historical requests associated with the content, historical user data associated with other users of other user devices, historical constraint data, and/or historical content data associated with the content. In some implementations, recommendation platform 110 trains the machine learning models with historical data (e.g., historical requests, historical user data, historical constraint data, and/or the like) to enable the machine learning models to determine a response to a request associated with content. For example, recommendation platform 110 may train the machine learning models in a manner similar to the manner described below in connection with FIG. 2. In some implementations, rather than training the machine learning models, recommendation platform 110 may obtain the machine learning models from another system or device that trained the machine learning models. In this case, recommendation platform 110 may provide the other system or device with historical data for use in training the machine learning models, and may provide the other system or device with updated historical data to retrain the machine learning models in order to update the machine learning models.

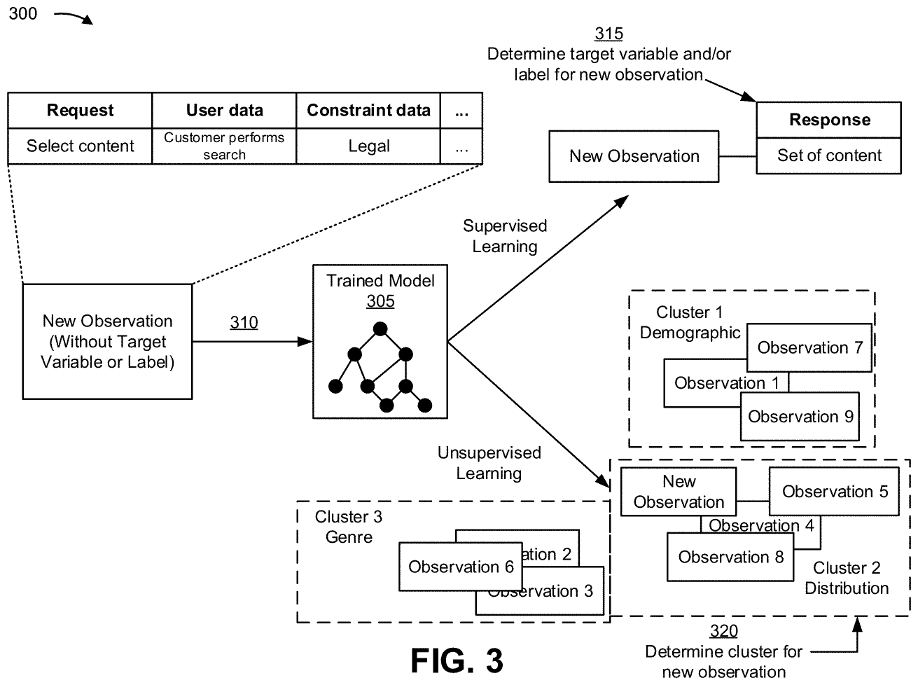

When processing the request, the user data, and/or the constraint data, recommendation platform 110 may apply the machine learning models in a manner similar to the manner described below in connection with FIG. 3.

Recommendation platform 110 may process the request, the user data, and the constraint data, with various combinations of the machine learning models, as described below. For example, recommendation platform 110 may utilize different combinations and/or orders of machine learning models based on whether the user is a customer (e.g., with an existing relationship with a provider of the content, such that information about the user is already known or available to recommendation platform 110) or a prospective customer (e.g., about whom recommendation platform 110 has no information or has only limited information). As another example, recommendation platform 110 may utilize different combinations and/or orders of machine learning models based on whether the user selected preferred content (e.g., preferred television channels as describe above in connection with FIG. 1A). As still another example, recommendation platform 110 may utilize different combinations and/or orders of machine learning models based on whether the response includes a first level recommendation or a second level recommendation. The constraint data may be utilized to apply the constraints before and/or after various processing steps (e.g., before and/or after processing by one or more of the machine learning models). In some cases, different constraints may be applied at different points before and/or after the various processing steps described below.

As described below in connection with FIGS. 1D-1G, the user may be a prospective customer who did not select preferred content. For example, the user may not have an existing relationship with a provider of the content, and may not have selected any channels. In this case, recommendation platform 110 may process the request, the user data, and/or the constraint data, with machine learning models based on user demographic data, frequency distribution of content, content genre data, content popularity data, and/or the like.

Prior to processing the request, the user data, and/or the constraint data, recommendation platform 110 may obtain information specific to the consumption of television linear programming channels by a group of users (e.g., from a content provider, from an external party, and/or the like) such as channel usage over a period of time (e.g., date, time, and viewing duration a user has tuned into channels), and may define a target unit to be optimized to capture the consumption behavior of items of content. The target unit may include a mathematical or quantitative representation of item consumption (e.g., a count of views on each channel where a duration of viewing is equal to or greater than a period of time (e.g., in minutes) during a trailing moving window of time (e.g., in days). In this case, an optimization may minimize channel surfing (e.g., flipping rapidly among channels) and maximize recent consumption behavior (e.g., based on the trailing moving window). Recommendation platform 110 may generate a distribution of the target unit for each user in the obtained information (e.g., distribution on a user basis to represent consumption patterns) based on aggregating the information obtained about users consumption of items relative to the defined target unit. For example, the distribution may include a frequency of views of each tuned-into channel for a selected user. In this case, the distribution may represent patterns among channel-specific target unit changes over time for all users included in the distribution.

As shown in FIG. 1D, and by reference number 118, recommendation platform 110 may process, when the user is a prospective customer and did not select preferred content, particular content accessed by the user and user demographic data, with a first machine learning model, to identify a first set of content. The user demographic data may include data associated with a geographic location of the user, such as a zip code of the user. For example, recommendation platform 110 may determine the zip code of the user based on an Internet protocol (IP) address of the user.

In some implementations, recommendation platform 110 may process the particular content accessed by the user and the user demographic data with the first machine learning model to generate one or more clusters of user consumption patterns that are based on user demographics, such as geographical locations (e.g., zip codes) of users. The grouping of the user consumption patterns may be based on user consumption of content items in aggregation (e.g., based on the defined target unit) and not explicit to characteristics of the content items. For example, in the case of linear television programming, the first machine learning model may purposely exclude characteristics of consumed content items, such as genre, director, context, focus, setting, production date, airing time, and/or the like. As such, the first machine learning model may rely on using one or more data elements other than the content item characteristics, with the exception of content item identification (e.g., a channel number). The first machine learning model may be an unsupervised learning model (e.g., may perform unsupervised clustering, wherein the number of clusters output is unknown, not fixed, and may change over each processing). Each cluster generated may have a different consumption pattern distinguished from the rest of the clusters according to one or more measures of dissimilarity employed by the first machine learning model.

The first machine learning model may have been trained based on historical data (e.g., historical particular content, historical user demographic data, and/or the like) to enable the first machine learning model to identify a first set of content. For example, recommendation platform 110 may train the first machine learning model in a manner similar to the manner described below in connection with FIG. 2. Rather than training the first machine learning model, recommendation platform 110 may obtain the first machine learning model from another system or device that trained the first machine learning model. In this case, recommendation platform 110 may provide the other system or device with historical data for use in training the first machine learning model, and may provide the other system or device with updated historical data to retrain the first machine learning model in order to update the first machine learning model.

When processing the particular content accessed by the user and the user demographic data, recommendation platform 110 may apply the first machine learning model in a manner similar to the manner described below in connection with FIG. 3.

As shown in FIG. 1E, and by reference number 120, recommendation platform 110 may process the first set of content and a frequency distribution of content, with a second machine learning model, to identify a second set of content. The second set of content may include a frequency distribution of channels, an account-weighted channel distribution, and/or the like.

Recommendation platform 110 may process the first set of content and the frequency distribution of content, with the second machine learning mode, to generate a separate account-weighted distribution for each user type of multiple user types. The user types may be based on anticipated data availability at a time of a request received from user device 105, as described above in connection with FIG. 1B. In this case, a first user type may be for a prospective user (e.g., anticipated to be associated with limited data availability in real-time), and a second user type may be for a customer (e.g., an existing customer for whom more identification information is known or becomes available in a real-time interaction).

Additionally, or alternatively, recommendation platform 110 may determine a user type after generating the clusters of user consumption patterns, as described above in connection with FIG. 1D. In this case, recommendation platform 110 may consume all available data collectively regardless of availability of user data to produce a set of consumption patterns, and when a user is interacting with recommendation platform 110. Recommendation platform 110 may obtain one or more data elements associated with the user, may compare the one or more data elements to one or more available characteristics of the clusters, and may match a user type to one of the previously generated clusters.

The second machine learning model may have been trained based on historical data (e.g., a historical first set of content, a historical frequency distribution of content, and/or the like) to enable the second machine learning model to identify a second set of content. For example, recommendation platform 110 may train the second machine learning model in a manner similar to the manner described below in connection with FIG. 2. Rather than training the second machine learning model, recommendation platform 110 may obtain the second machine learning model from another system or device that trained the second machine learning model. In this case, recommendation platform 110 may provide the other system or device with historical data for use in training the second machine learning model, and may provide the other system or device with updated historical data to retrain the second machine learning model in order to update the second machine learning model.

When processing the first set of content and the frequency distribution of content, recommendation platform 110 may apply the second machine learning model in a manner similar to the manner described below in connection with FIG. 3.

As shown in FIG. 1F, and by reference number 122, recommendation platform 110 may process the second set of content and content genre data, with a third machine learning model, to identify a third set of content. The content genre data may include content item metadata that may relate to a genre (e.g., news, sports, movies, documentaries, and/or the like) of content items and/or additional characteristics of content items. For example, in the case of television linear programming, the content item metadata may be associated with characteristics, such as a genre, a director, actors, season, scenes, a context, a thesis, a setting, a production date, an air time, and/or the like.

The third machine learning model may be a supervised learning model that performs supervised learning, such as supervised clustering, where the number of clusters output is known, fixed, and does not change over each processing. In this case, a cluster may be defined to represent at least one property of interest for the users. For example, in the case of television linear programming, a channel may be described by one of its properties such as genre, but may have more than one genre in addition to other metadata characteristics. Additionally, a cluster may be defined based on categories defined for ease of human interaction, user experience, marketing purposes, and/or the like. The third machine learning model may produce a mapping between pre-defined categories and the second set of content and content genre data. In this case, each category may be associated with one or more sets of items influenced by the user type.

The third machine learning model may have been trained based on historical data (e.g., a historical second set of content, historical content genre data, and/or the like) to enable the third machine learning model to identify a third set of content. For example, recommendation platform 110 may train the third machine learning model in a manner similar to the manner described below in connection with FIG. 2. In some implementations, rather than training the third machine learning model, recommendation platform 110 may obtain the third machine learning model from another system or device that trained the third machine learning model. In this case, recommendation platform 110 may provide the other system or device with historical data for use in training the third machine learning model, and may provide the other system or device with updated historical data to retrain the third machine learning model in order to update the third machine learning model.

When processing the second set of content and content genre data, recommendation platform 110 may apply the third machine learning model in a manner similar to the manner described below in connection with FIG. 3.

As shown in FIG. 1G, and by reference number 124, recommendation platform 110 may process the third set of content and content popularity data, with a fourth machine learning model, to identify a first level recommendation for the request of the prospective customer. The fourth machine learning model may utilize the content popularity data to identify content based on a measure of popularity, such as a frequency of usage of the content. Additionally, or alternatively, the fourth machine learning model may utilize the content popularity data to identify content based on a measure of popularity, such as duration of usage of the content. The measure of popularity may exclude usage that does not exceed a threshold duration (e.g., in minutes).

The fourth machine learning model may have been trained based on historical data (e.g., a historical third set of content, historical content popularity data, and/or the like) to enable the fourth machine learning model to identify a fourth set of content. For example, recommendation platform 110 may train the fourth machine learning model in a manner similar to the manner described below in connection with FIG. 2. In some implementations, rather than training the fourth machine learning model, recommendation platform 110 may obtain the fourth machine learning model from another system or device that trained the fourth machine learning model. In this case, recommendation platform 110 may provide the other system or device with historical data for use in training the fourth machine learning model, and may provide the other system or device with updated historical data to retrain the fourth machine learning model in order to update the fourth machine learning model.

When processing the third set of content and content popularity data, recommendation platform 110 may apply the fourth machine learning model in a manner similar to the manner described below in connection with FIG. 3.

As described below in connection with FIGS. 1H-1L, the user may be a prospective customer who selected preferred content. For example, the user may not have an existing relationship with a provider of the content and, in the scenario described above in connection with FIG. 1A, may have selected a quantity (e.g., five) of channels. In this case, recommendation platform 110 may process the request, the user data, and/or the constraint data, with machine learning models based on user demographic data, frequency distribution of content, content conditional probability, and content genre data, as described below. Prior to processing the request, the user data, and/or the constraint data, recommendation platform 110 may obtain information specific to the consumption of television linear programming channels by a group of users, may define a target unit to be optimized to capture the consumption behavior of the items, and may generate the distribution of the target unit for each user in the obtained information, in a manner similar to that described above in connection with FIGS. 1D-1G.

As shown in FIG. 1H, and by reference number 126, recommendation platform 110 may process, when the user is a prospective customer and selected preferred content, particular content accessed by the user and user demographic data, with the first machine learning model, to identify a first set of content. For example, recommendation platform 110 may process the particular content accessed by the user and user demographic data, with the first machine learning model, in a manner similar to that described above in connection with FIG. 1D.

As shown in FIG. 1I, and by reference number 128, recommendation platform 110 may process the first set of content and a frequency distribution of content, with the second machine learning model, to identify a second set of content. For example, recommendation platform 110 may process the first set of content and the frequency distribution of content, with the second machine learning model, in a manner similar to that described above in connection with FIG. 1E.

As shown in FIG. 1J, and by reference number 130, recommendation platform 110 may process the second set of content and content conditional probabilities, with a fifth machine learning model, to identify a third set of content. The fifth machine learning model may generate occurrence relationships among content items within each set of content items using a mathematical or statistical method to calculate conditional probabilities among content item occurrences over a period of time. The third set of content may include n pairwise conditional probabilities among the content items in each set of content items, where n may correspond to a quantity of items related by conditional probabilities. For example, if n=2, the pairwise conditional probabilities, for all combinations of two-item sets wherein the probability is a probability of occurrence of a first of the two items, may be calculated given that the second item has already occurred. As a specific example, if the content item is a television channel, the pairwise conditional probabilities would be the probability that channel A is viewed given that channel B has already been viewed during a period of time.

In some implementations, the fifth machine learning model may have been trained based on historical data (e.g., the historical second set of content, the historical content conditional probabilities, and/or the like) to enable the fifth machine learning model to identify a third set of content. For example, recommendation platform 110 may train the fifth machine learning model in a manner similar to the manner described below in connection with FIG. 2. Rather than training the fifth machine learning model, recommendation platform 110 may obtain the fifth machine learning model from another system or device that trained the fifth machine learning model. In this case, recommendation platform 110 may provide the other system or device with historical data for use in training the fifth machine learning model, and may provide the other system or device with updated historical data to retrain the fifth machine learning model in order to update the fifth machine learning model.

When processing the second set of content and content conditional probabilities, recommendation platform 110 may apply the fifth machine learning model in a manner similar to the manner described below in connection with FIG. 3.

As shown in FIG. 1K, and by reference number 132, recommendation platform 110 may process the third set of content and content genre data, with the third machine learning model, to identify a fourth set of content. For example, recommendation platform 110 may process the third set of content and the content genre data, with the third machine learning, model in a manner similar to that described above in connection with FIG. 1F.

As shown in FIG. 1L, and by reference number 134, recommendation platform 110 may assign conditional probabilities to the fourth set of content to generate a first level recommendation for the request of the prospective customer. For example, recommendation platform 110 may assign pairwise conditional probabilities (e.g., the n pairwise conditional probabilities generated by the fifth machine learning model, as described above in connection with FIG. 1J) based on the content genre-based clustering defined by the third machine learning model, as described above in connection with FIG. 1K.

As described below in connection with FIGS. 1M-1O, the user may be a customer who did not select preferred content. For example, similar to the scenario described above in connection with FIG. 1A, the user may be a current customer with a relationship with a provider of the content, and may not have selected any channels. In this case, recommendation platform 110 may process the request, the user data, and/or the constraint data, with machine learning models based on customer data, content genre data, and content popularity data, as described below. Prior to processing the request, the user data, and/or the constraint data, recommendation platform 110 may obtain information specific to the consumption of television linear programming channels by a group of users, may define a target unit to be optimized to capture the consumption behavior of the items, and may generate the distribution of the target unit for each user in the obtained information, in a manner similar to that described above in connection with FIGS. 1D-1G.

As shown in FIG. 1M, and by reference number 136, recommendation platform 110 may process, when the user is a customer (e.g., having an existing relationship with a provider of the content) and did not select preferred content, particular content accessed by the user and customer data, with a sixth machine learning model, to identify a first set of content. The customer data may include any information available to recommendation platform 110 based on the existing relationship of the customer. For example, the customer data may include characteristics of the customer (e.g., a geographic location of the customer, a race of the customer, an ethnicity of customer user, a gender of the customer, an age of the customer, an education level of the customer, a profession of the customer, an occupation of the customer, an income level of the customer, a marital status of the customer, and/or the like); preferences of the customer (e.g., customer selections of features available to the customer, content preferences as evidenced by content consumption by the customer, spending preferences as evidenced by spending on content by the customer, and/or the like); and/or the like.

Recommendation platform 110 may receive the customer data directly from user device 105, may receive the customer data from another system, that received the customer data directly from user device 105 and extracted, compiled, generated, and/or the like the customer data based on data received from user device 105, and/or the like. Recommendation platform 110 may periodically receive the customer data, may continuously receive the customer data, may receive the customer data based on a request, and/or the like. Recommendation platform 110 may store the customer data in a data structure (e.g., a database, a table, a list, and/or the like) associated with the recommendation platform 110. Recommendation platform 110 may receive the customer data over a predetermined time period (e.g., in minutes, hours, days, and/or the like). The predetermined time period may include a current time period, a most recent time period, a historical time period, and/or the like. The predetermined time period may be fixed or variable, may be customized (e.g., based on particular needs of an entity associated with the items), and/or the like. Data points associated with the customer data may be associated with time stamps, and recommendation platform 110 may determine that the data points are associated with the predetermined time period based on the time stamps.

Recommendation platform 110 may process the particular content accessed by the user and the customer data to generate one or more clusters of user consumption patterns. For example, recommendation platform 110 may process the particular content accessed by the user and the customer data in a similar manner to that described above in connection with the first machine learning model, but without being as restricted to limited information about the user as the first machine learning model, and thereby without necessarily being restricted to limited demographic data, such as geographical location.

The sixth machine learning model may have been trained based on historical data (e.g., the historical particular content accessed by the user, the historical customer data, and/or the like) to enable the sixth machine learning model to identify a first set of content. For example, recommendation platform 110 may train the sixth machine learning model in a manner similar to the manner described below in connection with FIG. 2. Rather than training the sixth machine learning model, recommendation platform 110 may obtain the sixth machine learning model from another system or device that trained the sixth machine learning model. In this case, recommendation platform 110 may provide the other system or device with historical data for use in training the sixth machine learning model, and may provide the other system or device with updated historical data to retrain the sixth machine learning model in order to update the sixth machine learning model.

When processing the particular content accessed by the user and the customer data, recommendation platform 110 may apply the sixth machine learning model in a manner similar to the manner described below in connection with FIG. 3.

As shown in FIG. 1N, and by reference number 138, recommendation platform 110 may process the first set of content and content genre data, with the third machine learning model, to identify a second set of content. For example, recommendation platform 110 may process the first set of content and the content genre data, with the third machine learning model, in a manner similar to that described above in connection with FIGS. 1F and 1K.

As shown in FIG. 1O, and by reference number 140, recommendation platform 110 may process the second set of content and content popularity data, with the fourth machine learning model, to identify a first level recommendation for the request of the customer. For example, recommendation platform 110 may process the second set of content and the content popularity data, with the fourth machine learning model, in a manner similar to that described above in connection with FIG. 1G. The fourth machine learning model may process the second set of content and content popularity data to identify categories of content. The categories of content may be based on content metadata, such as genre, directors, actors, shows sub-genre, setting, context, format, and/or the like.

As described below in connection with FIGS. 1P-1T, the user may be a customer who selected preferred content. For example, the user may be a current customer with a relationship with a provider of the content and, in the scenario described above in connection with FIG. 1A, may have selected a quantity (e.g., five) of channels. In this case, recommendation platform 110 may process the request, the user data, and/or the constraint data, with machine learning models based on customer data, frequency distribution of content, content conditional probability, and content genre data, as described below. Prior to processing the request, the user data, and/or the constraint data, recommendation platform 110 may obtain information specific to the consumption of television linear programming channels by a group of users, may define a target unit to be optimized to capture the consumption behavior of the items, and may generate the distribution of the target unit for each user in the obtained information, in a manner similar to that described above in connection with FIGS. 1D-1G.

As shown in FIG. 1P, and by reference number 142, recommendation platform 110 may process, when the user is a customer and selected preferred content, particular content accessed by the user and customer data, with the sixth machine learning model, to identify a first set of content. For example, recommendation platform 110 may process the particular content accessed by the user and the customer data, with the sixth machine learning model, in a manner similar to that described above in connection with FIG. 1M.

As shown in FIG. 1Q, and by reference number 144, recommendation platform 110 may process the first set of content and a frequency distribution of content, with the second machine learning model, to identify a second set of content. For example, recommendation platform 110 may process the first set of content and the frequency distribution of content, with the second machine learning model, in a manner similar to that described above in connection with FIGS. 1E and 1I.

As shown in FIG. 1R, and by reference number 146, recommendation platform 110 may process the second set of content and content conditional probabilities, with the fifth machine learning model, to identify a third set of content. For example, recommendation platform 110 may process the second set of content and the content conditional probabilities, with the fifth machine learning model, in a manner similar to that described above in connection with FIG. 1J.

As shown in FIG. 1S, and by reference number 148, recommendation platform 110 may process the third set of content and content genre data, with the third machine learning model, to identify a fourth set of content. For example, recommendation platform 110 may process the third set of content and the content genre data, with the third machine learning model, in a manner similar to that described above in connection with FIGS. 1F, 1K, and 1N.

As shown in FIG. 1T, and by reference number 150, recommendation platform 110 may assign conditional probabilities to the fourth set of content to generate a first level recommendation for the request of the customer. For example, recommendation platform 110 may assign pairwise conditional probabilities (e.g., the n pairwise conditional probabilities generated by the fifth machine learning model, as described above in connection with FIG. 1R) based on the content genre-based clustering defined by the third machine learning model as described above in connection with FIG. 1S.

As described below in connection with FIGS. 1U-1X, recommendation platform 110 may generate a second level recommendation based on preferred content selected by the user. For example, the user may be a prospective customer who selected preferred content. In this case, recommendation platform 110 may perform the steps described below in connection with FIGS. 1U-1V. Recommendation platform 110 may perform the steps described below in connection with FIGS. 1U-1V after performing the steps described above in connection with FIG. 1H-1L. As another example, the user may be a customer (e.g., a current customer with a relationship with a provider of the content) who selected preferred content. In this case, recommendation platform 110 may perform the steps described below in connection with FIGS. 1W-1X. Recommendation platform 110 may perform the steps described below in connection with FIGS. 1W-1X after performing the steps described above in connection with FIG. 1P-1T.

As shown in FIG. 1U, and by reference number 152, recommendation platform 110 may process, when the user is a prospective customer, preferred content selected by the user and user demographic data, with the first machine learning model, to identify a first set of content. For example, recommendation platform 110 may process the preferred content selected by the user and the user demographic data, with the first machine learning model, in a manner similar to that described above in connection with FIGS. 1D and 1H.

As shown in FIG. 1V, and by reference number 154, recommendation platform 110 may assign conditional probabilities to the first set of content to generate a second level recommendation for the request of the prospective customer. For example, recommendation platform 110 may assign pairwise conditional probabilities based on a cluster of a conditional channel (e.g., based on a quantity of accounts across a population).

As shown in FIG. 1W, and by reference number 156, recommendation platform 110 may process, when the user is a customer, preferred content selected by the user and customer data, with the sixth machine learning model, to identify a first set of content. For example, recommendation platform 110 may process the preferred content selected by the user and the customer data, with the sixth machine learning model, in a manner similar to that described above in connection with FIGS. 1M and 1P.

As shown in FIG. 1X, and by reference number 158, recommendation platform 110 may assign conditional probabilities to the first set of content to generate a second level recommendation for the request of the customer. For example, recommendation platform 110 may assign pairwise conditional probabilities based on a customer segment of a conditional channel (e.g., based on an account).

As shown in FIG. 1Y, and by reference number 160, recommendation platform 110 may perform one or more actions based on the response to the request. The one or more actions may include recommendation platform 110 providing a user interface that includes the response to the request. For example, recommendation platform 110 may provide a graphical user interface to be displayed by user device 105. The user interface may display the response (e.g., first level recommendations, second level recommendations, and/or the like), and may continuously update the response based on input by the user. In this way, recommendation platform 110 may enable the particular customer to view the response, to select or reject recommended content items, to further hone or adjust selections, and/or the like, which may improve the accuracy and efficiency of providing content recommendations to the user, thereby improving user experience and conserving computing resources, networking resources, and/or the like.

The one or more actions may include recommendation platform 110 causing the response to be implemented for the user via user device 105. For example, recommendation platform 110 may assemble content recommendations in the form of a content package, and may generate an offer for the user to purchase the content package, lease the content package, subscribe to the content package, sample the content package, and/or the like. Additionally, if the user accepts the offer, recommendation platform 110 may cause content included in the content package to be provided for consumption by the user. In this way, recommendation platform 110 may simplify the process and improve the speed and efficiency of the user acquiring and consuming content, which may conserve computing resources, networking resources, and/or the like that would otherwise have been required to manually assemble, offer, and/or acquire a content package.

The one or more actions may include recommendation platform 110 determining additional recommended content for the user based on the response to the request. For example, if the response includes first level recommendations, as described above, recommendation platform 110 may determine second level recommendations, preferred content, and/or additional information, and/or the like based on the first level recommendations. The second level recommendations may include some or all of the content items included in the first level recommendations, local channels, regional channels, user-selected channels, a larger set of linear programming channels, and/or the like. In this way, recommendation platform 110 may expand and/or improve recommendations automatically, thereby improving the efficiency and effectiveness of recommending content to the user.

The one or more actions may include recommendation platform 110 determining whether the user acts on the response to the request. For example, if the response is a content package, the user may utilize user device 105 to purchase the content package, lease the content package, subscribe to the content package, sample the content package, and/or the like. In this way, recommendation platform 110 may offer alternative recommendations to the user when the user does not act on the recommendation, may provide information indicating that the user acts on the item recommendation to one or more of the machine learning models to improve the quality of recommendations, and/or the like.

The one or more actions may include recommendation platform 110 revising the response to the request based on feedback from the user regarding the response to the request. For example, recommendation platform 110 may receive, from user device 105, feedback associated with the response to the request; may process the feedback, with one or more of the machine learning models, to determine a modified response to the request; and may provide the modified response to user device 105. In this way, recommendation platform 110 may improve the quality of content recommendations to the user, thereby improving user experience, improving the likelihood of a continued relationship with the user, generating additional purchases or rentals by the user, and/or the like.

The one or more actions may include recommendation platform 110 retraining one or more of the machine learning models based on the response to the request. For example, recommendation platform 110 may retrain the first machine learning model, second machine learning model, third machine learning model, fourth machine learning model, fifth machine learning model, and/or sixth machine learning model to identify sets of content, generate recommendations, and/or the like based on the response to the request. In this way, recommendation platform 110 may improve the accuracy of one or more of the machine learning models in determining a response to the request, which may improve speed and efficiency of one or more of the machine learning models and conserve computing resources, networking resources, and/or the like.

In this way, several different stages of the process for generating content package recommendations for current and prospective customers are automated with machine learning models, which may remove human subjectivity and waste from the process, and which may improve speed and efficiency of the process and conserve computing resources (e.g., processing resources, memory resources, and/or the like), communication resources, networking resources, and/or the like. Furthermore, implementations described herein use a rigorous, computerized process to perform tasks or roles that were not previously performed or were previously performed using subjective human intuition or input. For example, currently there does not exist a technique that utilizes machine learning models to generate content package recommendations for current and prospective customers in the manner described herein. Finally, the process for utilizing machine learning models to generate content package recommendations for current and prospective customers conserves computing resources, communication resources, networking resources, and/or the like that would otherwise have been wasted in identifying incorrect recommendations of content, implementing the incorrect recommendations, correcting the incorrect recommendations if discovered, and/or the like.

As indicated above, FIGS. 1A-1Y are provided merely as examples. Other examples may differ from what was described with regard to FIGS. 1A-1Y. The number and arrangement of devices and networks shown in FIGS. 1A-1Y are provided as an example. In practice, there may be additional devices and/or networks, fewer devices and/or networks, different devices and/or networks, or differently arranged devices and/or networks than those shown in FIGS. 1A-1Y. Furthermore, two or more devices shown in FIGS. 1A-1Y may be implemented within a single device, or a single device shown in FIGS. 1A-1Y may be implemented as multiple, distributed devices. Additionally, or alternatively, a set of devices (e.g., one or more devices) of FIGS. 1A-1Y may perform one or more functions described as being performed by another set of devices of FIGS. 1A-1Y.

FIG. 2 is a diagram illustrating an example 200 of training a machine learning model. The machine learning model training described herein may be performed using a machine learning system. The machine learning system may include a computing device, a server, a cloud computing environment, and/or the like, such as user device 105 and/or recommendation platform 110.

As shown by reference number 205, a machine learning model may be trained using a set of observations. The set of observations may be obtained and/or input from historical data, such as data gathered during one or more processes described herein. For example, the set of observations may include data gathered from user interaction with and/or user input to user device 105, as described elsewhere herein. In some implementations, the machine learning system may receive the set of observations (e.g., as input) from user device 105.

As shown by reference number 210, a feature set may be derived from the set of observations. The feature set may include a set of variable types. A variable type may be referred to as a feature. A specific observation may include a set of variable values corresponding to the set of variable types. A set of variables values may be specific to an observation. In some cases, different observations may be associated with different sets of variable values, sometimes referred to as feature values. In some implementations, the machine learning system may determine variable values for a specific observation based on input received from user device 105. For example, the machine learning system may identify a feature set (e.g., one or more features and/or corresponding feature values) from structured data input to the machine learning system, such as by extracting data from a particular column of a table, extracting data from a particular field of a form, extracting data from a particular field of a message, extracting data received in a structured data format, and/or the like. In some implementations, the machine learning system may determine features (e.g., variables types) for a feature set based on input received from user device 105, such as by extracting or generating a name for a column, extracting or generating a name for a field of a form and/or a message, extracting or generating a name based on a structured data format, and/or the like. Additionally, or alternatively, the machine learning system may receive input from an operator to determine features and/or feature values. In some implementations, the machine learning system may perform natural language processing and/or another feature identification technique to extract features (e.g., variable types) and/or feature values (e.g., variable values) from text (e.g., unstructured data) input to the machine learning system, such as by identifying keywords and/or values associated with those keywords from the text.

As an example, a feature set for a set of observations may include a first feature of a request, a second feature of user data, a third feature of constraint data, and so on. As shown, for a first observation, the first feature may have a value of select content, the second feature may have a value of perform search, the third feature may have a value of financial constraint, and so on. These features and feature values are provided as examples, and may differ in other examples. For example, the feature set may include one or more of the following features: request data (e.g., a selection of a set of content), user data (e.g., customer, prospective customer, perform a search, select a category, select a genre, and/or the like), constraint data (e.g., content combinations, quantity of content to recommend, legal restrictions, financial optimization, dynamic personalization, current customer, prospective customer, and/or the like), and/or the like. In some implementations, the machine learning system may pre-process and/or perform dimensionality reduction to reduce the feature set and/or combine features of the feature set to a minimum feature set. A machine learning model may be trained on the minimum feature set, thereby conserving resources of the machine learning system (e.g., processing resources, memory, and/or the like) used to train the machine learning model.

As shown by reference number 215, the set of observations may be associated with a target variable type. The target variable type may represent a variable having a numeric value (e.g., an integer value, a floating point value, and/or the like), may represent a variable having a numeric value that falls within a range of values or has some discrete possible values, may represent a variable that is selectable from one of multiple options (e.g., one of multiples classes, classifications, labels, and/or the like), may represent a variable having a Boolean value (e.g., 0 or 1, True or False, Yes or No), and/or the like. A target variable type may be associated with a target variable value, and a target variable value may be specific to an observation. In some cases, different observations may be associated with different target variable values.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model, a predictive model, and/or the like. When the target variable type is associated with continuous target variable values (e.g., a range of numbers and/or the like), the machine learning model may employ a regression technique. When the target variable type is associated with categorical target variable values (e.g., classes, labels, and/or the like), the machine learning model may employ a classification technique.

In some implementations, the machine learning model may be trained on a set of observations that do not include a target variable (or that include a target variable, but the machine learning model is not being executed to predict the target variable). This may be referred to as an unsupervised learning model, an automated data analysis model, an automated signal extraction model, and/or the like. In this case, the machine learning model may learn patterns from the set of observations without labeling or supervision, and may provide output that indicates such patterns, such as by using clustering and/or association to identify related groups of items within the set of observations.

As further shown, the machine learning system may partition the set of observations into a training set 220 that includes a first subset of observations, of the set of observations, and a test set 225 that includes a second subset of observations of the set of observations. The training set 220 may be used to train (e.g., fit, tune, and/or the like) the machine learning model, while the test set 225 may be used to evaluate a machine learning model that is trained using the training set 220. For example, for supervised learning, the test set 220 may be used for initial model training using the first subset of observations, and the test set 225 may be used to test whether the trained model accurately predicts target variables in the second subset of observations. In some implementations, the machine learning system may partition the set of observations into the training set 220 and the test set 225 by including a first portion or a first percentage of the set of observations in the training set 220 (e.g., 75%, 80%, or 85%, among other examples) and including a second portion or a second percentage of the set of observations in the test set 225 (e.g., 25%, 20%, or 15%, among other examples). In some implementations, the machine learning system may randomly select observations to be included in the training set 220 and/or the test set 225.

As shown by reference number 230, the machine learning system may train a machine learning model using the training set 220. This training may include executing, by the machine learning system, a machine learning algorithm to determine a set of model parameters based on the training set 220. In some implementations, the machine learning algorithm may include a regression algorithm (e.g., linear regression, logistic regression, and/or the like), which may include a regularized regression algorithm (e.g., Lasso regression, Ridge regression, Elastic-Net regression, and/or the like). Additionally, or alternatively, the machine learning algorithm may include a decision tree algorithm, which may include a tree ensemble algorithm (e.g., generated using bagging and/or boosting), a random forest algorithm, a boosted trees algorithm, and/or the like. A model parameter may include an attribute of a machine learning model that is learned from data input into the model (e.g., the training set 220). For example, for a regression algorithm, a model parameter may include a regression coefficient (e.g., a weight). For a decision tree algorithm, a model parameter may include a decision tree split location, as an example.

As shown by reference number 235, the machine learning system may use one or more hyperparameter sets 240 to tune the machine learning model. A hyperparameter may include a structural parameter that controls execution of a machine learning algorithm by the machine learning system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the machine learning model to the training set 220. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), may be applied by setting one or more feature values to zero (e.g., for automatic feature selection), and/or the like. Example hyperparameters for a decision tree algorithm include a tree ensemble technique to be applied (e.g., bagging, boosting, a random forest algorithm, a boosted trees algorithm, and/or the like), a number of features to evaluate, a number of observations to use, a maximum depth of each decision tree (e.g., a number of branches permitted for the decision tree), a number of decision trees to include in a random forest algorithm, and/or the like.

To train a machine learning model, the machine learning system may identify a set of machine learning algorithms to be trained (e.g., based on operator input that identifies the one or more machine learning algorithms, based on random selection of a set of machine learning algorithms, and/or the like), and may train the set of machine learning algorithms (e.g., independently for each machine learning algorithm in the set) using the training set 220. The machine learning system may tune each machine learning algorithm using one or more hyperparameter sets 240 (e.g., based on operator input that identifies hyperparameter sets 240 to be used, based on randomly generating hyperparameter values, and/or the like). The machine learning system may train a particular machine learning model using a specific machine learning algorithm and a corresponding hyperparameter set 240. In some implementations, the machine learning system may train multiple machine learning models to generate a set of model parameters for each machine learning model, where each machine learning model corresponds to a different combination of a machine learning algorithm and a hyperparameter set 240 for that machine learning algorithm.

In some implementations, the machine learning system may perform cross-validation when training a machine learning model. Cross validation can be used to obtain a reliable estimate of machine learning model performance using only the training set 220, and without using the test set 225, such as by splitting the training set 220 into a number of groups (e.g., based on operator input that identifies the number of groups, based on randomly selecting a number of groups, and/or the like) and using those groups to estimate model performance. For example, using k-fold cross-validation, observations in the training set 220 may be split into k groups (e.g., in order or at random). For a training procedure, one group may be marked as a hold-out group, and the remaining groups may be marked as training groups. For the training procedure, the machine learning system may train a machine learning model on the training groups and then test the machine learning model on the hold-out group to generate a cross-validation score. The machine learning system may repeat this training procedure using different hold-out groups and different test groups to generate a cross-validation score for each training procedure. In some implementations, the machine learning system may independently train the machine learning model k times, with each individual group being used as a hold-out group once and being used as a training group k−1 times. The machine learning system may combine the cross-validation scores for each training procedure to generate an overall cross-validation score for the machine learning model. The overall cross-validation score may include, for example, an average cross-validation score (e.g., across all training procedures), a standard deviation across cross-validation scores, a standard error across cross-validation scores, and/or the like.

In some implementations, the machine learning system may perform cross-validation when training a machine learning model by splitting the training set into a number of groups (e.g., based on operator input that identifies the number of groups, based on randomly selecting a number of groups, and/or the like). The machine learning system may perform multiple training procedures and may generate a cross-validation score for each training procedure. The machine learning system may generate an overall cross-validation score for each hyperparameter set 240 associated with a particular machine learning algorithm. The machine learning system may compare the overall cross-validation scores for different hyperparameter sets 240 associated with the particular machine learning algorithm, and may select the hyperparameter set 240 with the best (e.g., highest accuracy, lowest error, closest to a desired threshold, and/or the like) overall cross-validation score for training the machine learning model. The machine learning system may then train the machine learning model using the selected hyperparameter set 240, without cross-validation (e.g., using all of data in the training set 220 without any hold-out groups), to generate a single machine learning model for a particular machine learning algorithm. The machine learning system may then test this machine learning model using the test set 225 to generate a performance score, such as a mean squared error (e.g., for regression), a mean absolute error (e.g., for regression), an area under receiver operating characteristic curve (e.g., for classification), and/or the like. If the machine learning model performs adequately (e.g., with a performance score that satisfies a threshold), then the machine learning system may store that machine learning model as a trained machine learning model 245 to be used to analyze new observations, as described below in connection with FIG. 3.

In some implementations, the machine learning system may perform cross-validation, as described above, for multiple machine learning algorithms (e.g., independently), such as a regularized regression algorithm, different types of regularized regression algorithms, a decision tree algorithm, different types of decision tree algorithms, and/or the like. Based on performing cross-validation for multiple machine learning algorithms, the machine learning system may generate multiple machine learning models, where each machine learning model has the best overall cross-validation score for a corresponding machine learning algorithm. The machine learning system may then train each machine learning model using the entire training set 220 (e.g., without cross-validation), and may test each machine learning model using the test set 225 to generate a corresponding performance score for each machine learning model. The machine learning model may compare the performance scores for each machine learning model, and may select the machine learning model with the best (e.g., highest accuracy, lowest error, closest to a desired threshold, and/or the like) performance score as the trained machine learning model 245.

As indicated above, FIG. 2 is provided as an example. Other examples may differ from what is described in connection with FIG. 2. For example, the machine learning model may be trained using a different process than what is described in connection with FIG. 2. Additionally, or alternatively, the machine learning model may employ a different machine learning algorithm than what is described in connection with FIG. 2, such as a Bayesian estimation algorithm, a k-nearest neighbor algorithm, an a priori algorithm, a k-means algorithm, a support vector machine algorithm, a neural network algorithm (e.g., a convolutional neural network algorithm), a deep learning algorithm, and/or the like.

FIG. 3 is a diagram illustrating an example 300 of applying a trained machine learning model to a new observation. The new observation may be input to a machine learning system that stores a trained machine learning model 305. In some implementations, the trained machine learning model 305 may be the trained machine learning model 245 described above in connection with FIG. 2. The machine learning system may include a computing device, a server, a cloud computing environment, and/or the like, such as recommendation platform 110.

As shown by reference number 310, the machine learning system may receive a new observation (or a set of new observations), and may input the new observation to the machine learning model 305. As shown, the new observation may include a first feature of a request, a second feature of user data, a third feature of constraint data, and so on, as an example. The machine learning system may apply the trained machine learning model 305 to the new observation to generate an output (e.g., a result). The type of output may depend on the type of machine learning model and/or the type of machine learning task being performed. For example, the output may include a predicted (e.g., estimated) value of target variable (e.g., a value within a continuous range of values, a discrete value, a label, a class, a classification, and/or the like), such as when supervised learning is employed. Additionally, or alternatively, the output may include information that identifies a cluster to which the new observation belongs, information that indicates a degree of similarity between the new observations and one or more prior observations (e.g., which may have previously been new observations input to the machine learning model and/or observations used to train the machine learning model), and/or the like, such as when unsupervised learning is employed.

In some implementations, the trained machine learning model 305 may predict a value of a set of content for the target variable of a response for the new observation, as shown by reference number 315. Based on this prediction (e.g., based on the value having a particular label/classification, based on the value satisfying or failing to satisfy a threshold, and/or the like), the machine learning system may provide a recommendation, such as a first level recommendation (e.g., a particular quantity of content that is personalized for the user), a second level recommendation (e.g., a larger quantity of content than the particular quantity of content in the first level recommendation, and which is personalized for the user). Additionally, or alternatively, the machine learning system may perform an automated action and/or may cause an automated action to be performed (e.g., by instructing another device to perform the automated action), such as provide the recommendation to user device 105, revise the response based on feedback associated with the response. As another example, if the machine learning system were to predict a value of another set of content for the target variable of the response, then the machine learning system may provide a different recommendation (e.g., a different first level recommendation) and/or may perform or cause performance of a different automated action (e.g., cause user device 105 to implement the different first level recommendation). In some implementations, the recommendation and/or the automated action may be based on the target variable value having a particular label (e.g., classification, categorization, and/or the like), may be based on whether the target variable value satisfies one or more threshold (e.g., whether the target variable value is greater than a threshold, is less than a threshold, is equal to a threshold, falls within a range of threshold values, and/or the like), and/or the like.

In some implementations, the trained machine learning model 305 may classify (e.g. cluster) the new observation in a demographic cluster, as shown by reference number 320. The observations within a cluster may have a threshold degree of similarity. Based on classifying the new observation in the demographic cluster, the machine learning system may provide a recommendation, such as content relevant to demographics. Additionally, or alternatively, the machine learning system may perform an automated action and/or may cause an automated action to be performed (e.g., by instructing another device to perform the automated action), such as provide the response to user device 105 associated with a user in the demographic. As another example, if the machine learning system were to classify the new observation in a distribution cluster, then the machine learning system may provide a different recommendation (e.g., content relevant to content distribution) and/or may perform or cause performance of a different automated action (e.g., cause the content relevant to content distribution to be implemented by user device 105).

In this way, the machine learning system may apply a rigorous and automated process to generate content package recommendations customized for current and prospective customers. The machine learning system enables recognition and/or identification of tens, hundreds, thousands, or millions of features and/or feature values for tens, hundreds, thousands, or millions of observations, thereby increasing an accuracy and consistency of content package recommendations customized for current and prospective customers relative to requiring computing resources to be allocated for tens, hundreds, or thousands of operators to manually determine content package recommendations customized for current and prospective customers using the features or feature values.

As indicated above, FIG. 3 is provided as an example. Other examples may differ from what is described in connection with FIG. 3.

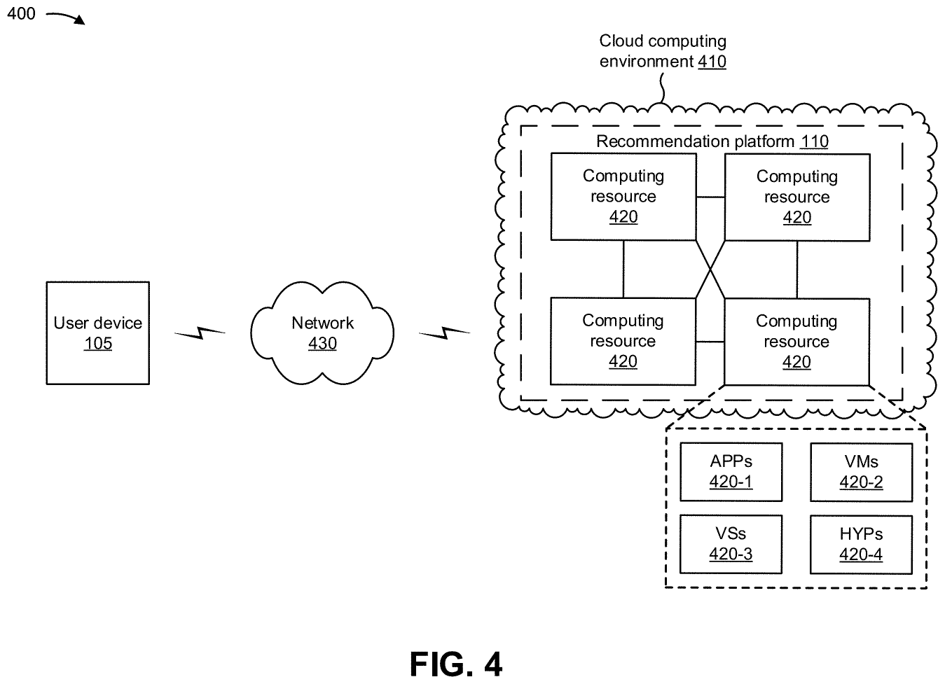

FIG. 4 is a diagram of an example environment 400 in which systems and/or methods described herein may be implemented. As shown in FIG. 4, environment 400 may include user device 105, a recommendation platform 110, and a network 430. Devices of environment 400 may interconnect via wired connections, wireless connections, or a combination of wired and wireless connections.

User device 105 includes one or more devices capable of receiving, generating, storing, processing, and/or providing information, such as information described herein. For example, user device 105 may include a mobile phone (e.g., a smart phone, a radiotelephone, and/or the like), a laptop computer, a tablet computer, a desktop computer, a handheld computer, a set-top box, a gaming device, a wearable communication device (e.g., a smart watch, a pair of smart glasses, a heart rate monitor, a fitness tracker, smart clothing, smart jewelry, a head mounted display, and/or the like) or a similar type of device. In some implementations, user device 105 may receive information from and/or transmit information to recommendation platform 110.

Recommendation platform 110 includes one or more devices that utilize machine learning models to generate content package recommendations for current and prospective customers. In some implementations, recommendation platform 110 may be designed to be modular such that certain software components may be swapped in or out depending on a particular need. As such, recommendation platform 110 may be easily and/or quickly reconfigured for different uses. In some implementations, recommendation platform 110 may receive information from and/or transmit information to one or more user devices 105.

In some implementations, as shown, recommendation platform 110 may be hosted in a cloud computing environment 410. Notably, while implementations described herein describe recommendation platform 110 as being hosted in cloud computing environment 410, in some implementations, recommendation platform 110 may not be cloud-based (i.e., may be implemented outside of a cloud computing environment) or may be partially cloud-based.

Cloud computing environment 410 includes an environment that hosts recommendation platform 110. Cloud computing environment 410 may provide computation, software, data access, storage, etc., services that do not require end-user knowledge of a physical location and configuration of system(s) and/or device(s) that hosts recommendation platform 110. As shown, cloud computing environment 410 may include a group of computing resources 420 (referred to collectively as “computing resources 420” and individually as “computing resource 420”).

Computing resource 420 includes one or more personal computers, workstation computers, mainframe devices, or other types of computation and/or communication devices. In some implementations, computing resource 420 may host recommendation platform 110. The cloud resources may include compute instances executing in computing resource 420, storage devices provided in computing resource 420, data transfer devices provided by computing resource 420, and/or the like. In some implementations, computing resource 420 may communicate with other computing resources 420 via wired connections, wireless connections, or a combination of wired and wireless connections.

As further shown in FIG. 4, computing resource 420 includes a group of cloud resources, such as one or more applications (“APPs”) 420-1, one or more virtual machines (“VMs”) 420-2, virtualized storage (“VSs”) 420-3, one or more hypervisors (“HYPs”) 420-4, and/or the like.

Application 420-1 includes one or more software applications that may be provided to or accessed by user device 105. Application 420-1 may eliminate a need to install and execute the software applications on user device 105. For example, application 420-1 may include software associated with recommendation platform 110 and/or any other software capable of being provided via cloud computing environment 410. In some implementations, one application 420-1 may send/receive information to/from one or more other applications 420-1, via virtual machine 420-2.

Virtual machine 420-2 includes a software implementation of a machine (e.g., a computer) that executes programs like a physical machine. Virtual machine 420-2 may be either a system virtual machine or a process virtual machine, depending upon use and degree of correspondence to any real machine by virtual machine 420-2. A system virtual machine may provide a complete system platform that supports execution of a complete operating system (“OS”). A process virtual machine may execute a single program and may support a single process. In some implementations, virtual machine 420-2 may execute on behalf of a user (e.g., a user of user device 105 or an operator of recommendation platform 110), and may manage infrastructure of cloud computing environment 410, such as data management, synchronization, or long-duration data transfers.

Virtualized storage 420-3 includes one or more storage systems and/or one or more devices that use virtualization techniques within the storage systems or devices of computing resource 420. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 420-4 may provide hardware virtualization techniques that allow multiple operating systems (e.g., “guest operating systems”) to execute concurrently on a host computer, such as computing resource 420. Hypervisor 420-4 may present a virtual operating platform to the guest operating systems and may manage the execution of the guest operating systems. Multiple instances of a variety of operating systems may share virtualized hardware resources.

Network 430 includes one or more wired and/or wireless networks. For example, network 430 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or the like, and/or a combination of these or other types of networks.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

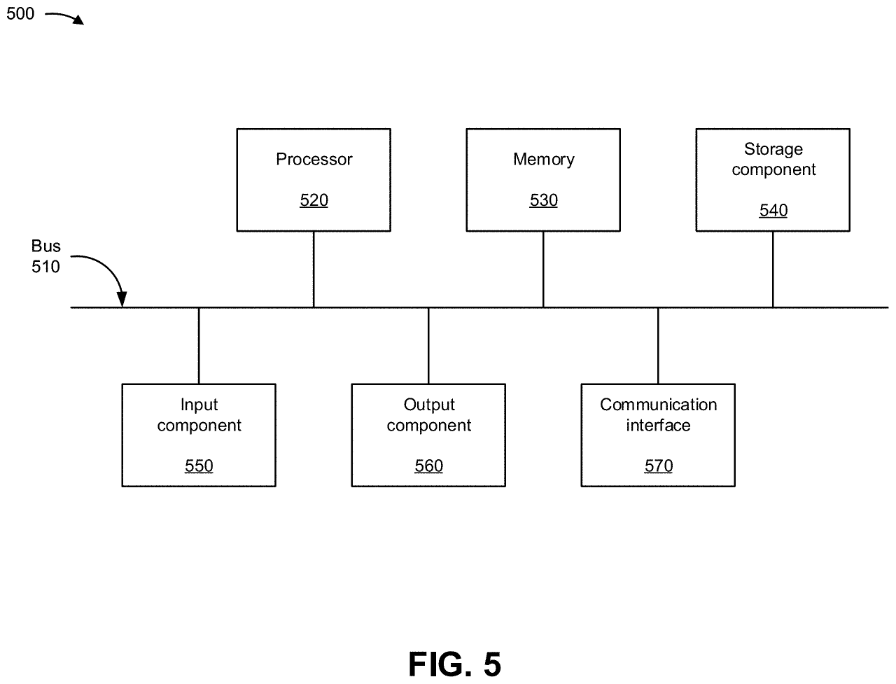

FIG. 5 is a diagram of example components of a device 500. Device 500 may correspond to user device 105, recommendation platform 110, and/or computing resource 420. In some implementations, user device 105, recommendation platform 110, and/or computing resource 420 may include one or more devices 500 and/or one or more components of device 500. As shown in FIG. 5, device 500 may include a bus 510, a processor 520, a memory 530, a storage component 540, an input component 550, an output component 560, and a communication interface 570.

Bus 510 includes a component that permits communication among the components of device 500. Processor 520 is implemented in hardware, firmware, or a combination of hardware and software. Processor 520 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 520 includes one or more processors capable of being programmed to perform a function. Memory 530 includes a random-access memory (RAM), a read only memory (ROM), and/or another type of dynamic or static storage device (e.g., a flash memory, a magnetic memory, and/or an optical memory) that stores information and/or instructions for use by processor 520.

Storage component 540 stores information and/or software related to the operation and use of device 500. For example, storage component 540 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 550 includes a component that permits device 500 to receive information, such as via user input (e.g., a touch screen display, a keyboard, a keypad, a mouse, a button, a switch, and/or a microphone). Additionally, or alternatively, input component 550 may include a sensor for sensing information (e.g., a global positioning system (GPS) component, an accelerometer, a gyroscope, and/or an actuator). Output component 560 includes a component that provides output information from device 500 (e.g., a display, a speaker, and/or one or more light-emitting diodes (LEDs)).

Communication interface 570 includes a transceiver-like component (e.g., a transceiver and/or a separate receiver and transmitter) that enables device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

Device 500 may perform one or more processes described herein. Device 500 may perform these processes based on processor 520 executing software instructions stored by a non-transitory computer-readable medium, such as memory 530 and/or storage component 540. A computer-readable medium is defined herein as a non-transitory memory device. A memory device includes memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 5 are provided as an example. In practice, device 500 may include additional components, fewer components, different components, or differently arranged components than those shown in FIG. 5. Additionally, or alternatively, a set of components (e.g., one or more components) of device 500 may perform one or more functions described as being performed by another set of components of device 500.

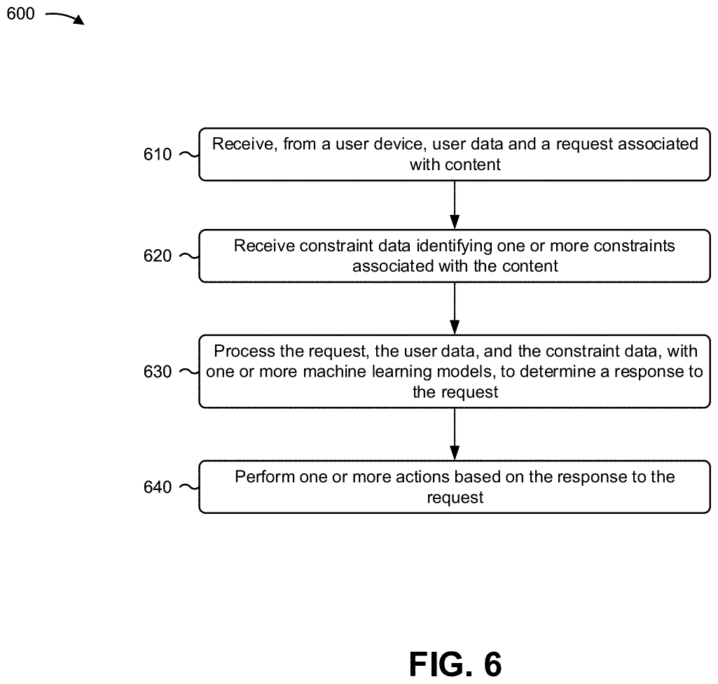

FIG. 6 is a flow chart of an example process 600 for utilizing machine learning models to generate content package recommendations for current and prospective customers. In some implementations, one or more process blocks of FIG. 6 may be performed by a device (e.g., recommendation platform 110). In some implementations, one or more process blocks of FIG. 6 may be performed by another device or a group of devices separate from or including the device, such as a user device (e.g., user device 105).

As shown in FIG. 6, process 600 may include receiving, from a user device, user data and a request associated with content (block 610). For example, the device (e.g., using computing resource 420, processor 520, communication interface 570, and/or the like) may receive, from a user device, user data and a request associated with content, as described above. In some implementations, the user data may identify one or more of an action of a user of the user device, a behavior of the user, or a feature associated with the user. In some implementations, the request may include data identifying particular content accessed by the user for a particular time period. In some implementations, the content may include one or more linear programming channels, video-on-demand content, music content, one or more games, one or more widgets, or one or more applications.

As further shown in FIG. 6, process 600 may include receiving constraint data identifying one or more constraints associated with the content (block 620). For example, the device (e.g., using computing resource 420, processor 520, communication interface 570, and/or the like) may receive constraint data identifying one or more constraints associated with the content, as described above.

As further shown in FIG. 6, process 600 may include processing the request, the user data, and the constraint data, with one or more machine learning models, to determine a response to the request (block 630). For example, the device (e.g., using computing resource 420, processor 520, memory 530, and/or the like) may process the request, the user data, and the constraint data, with one or more machine learning models, to determine a response to the request, as described above. In some implementations, the response to the request may include a recommended set of the content for the user, and the one or more machine learning models may be trained based on one or more of historical requests associated with the content, historical user data associated with other users of other user devices, historical constraint data, or historical content data associated with the content.

In some implementations, when the user is a prospective customer, processing the request, the user data, and the constraint data, with the one or more machine learning models, to determine the response to the request may include processing particular content accessed by the user and user demographic data, with a first machine learning model of the one or more machine learning models, to identify a first set of content; processing the first set of content and a frequency distribution of the content, with a second machine learning model of the one or more machine learning models, to identify a second set of content; processing the second set of content and content genre data associated with the content, with a third machine learning model of the one or more machine learning models, to identify a third set of content; and processing the third set of content and content popularity data associated with the content, with a fourth machine learning model of the one or more machine learning models, to identify a first level recommendation as the response for the request, wherein the first level recommendation may identify a particular quantity of the third set of content.

In some implementations, when the user is a prospective customer and selected preferred content from the content, processing the request, the user data, and the constraint data, with the one or more machine learning models, to determine the response to the request may include processing particular content accessed by the user and user demographic data, with a first machine learning model of the one or more machine learning models, to identify a first set of content; processing the first set of content and a frequency distribution of the content, with a second machine learning model of the one or more machine learning models, to identify a second set of content; processing the second set of content and conditional probabilities of the content, with a third machine learning model of the one or more machine learning models, to identify a third set of content; processing the third set of content and content genre data associated with the content, with a fourth machine learning model of the one or more machine learning models, to identify a fourth set of content; and assigning conditional probabilities to the fourth set of content to generate a first level recommendation as the response for the request, wherein the first level recommendation may identify a first particular quantity of the fourth set of content.

In some implementations, process 600 may include processing the preferred content selected by the user and the user demographic data, with a fifth machine learning model of the one or more machine learning models, to identify a fifth set of content; and assigning additional conditional probabilities to the fifth set of content to generate a second level recommendation as the response for the request, wherein the second level recommendation may identify a second particular quantity of the fifth set of content, and wherein the second particular quantity is being greater than the first particular quantity.

In some implementations, when the user is a customer, processing the request, the user data, and the constraint data, with the one or more machine learning models, to determine the response to the request may include processing particular content accessed by the user and customer data associated with the user, with a first machine learning model of the one or more machine learning models, to identify a first set of content; processing the first set of content and content genre data associated with the content, with a second machine learning model of the one or more machine learning models, to identify a second set of content; and processing the second set of content and content popularity data associated with the content, with a fourth machine learning model of the one or more machine learning models, to identify a first level recommendation as the response for the request, wherein the first level recommendation may identify a particular quantity of the second set of content.

In some implementations, when the user is a customer and selected preferred content from the content, processing the request, the user data, and the constraint data, with the one or more machine learning models, to determine the response to the request may include processing particular content accessed by the user and customer data associated with the user, with a first machine learning model of the one or more machine learning models, to identify a first set of content; processing the first set of content and a frequency distribution of the content, with a second machine learning model of the one or more machine learning models, to identify a second set of content; processing the second set of content and content conditional probabilities of the content, with a third machine learning model of the one or more machine learning models, to identify a third set of content; processing the third set of content and content genre data associated with the content, with a fourth machine learning model of the one or more machine learning models, to identify a fourth set of content; and assigning conditional probabilities to the fourth set of content to generate a first level recommendation as the response for the request, wherein the first level recommendation may identify a first particular quantity of the fourth set of content.

In some implementations, process 600 may include processing the preferred content selected by the user and the customer data, with a fifth machine learning model of the one or more machine learning models, to identify a fifth set of content; and assigning additional conditional probabilities to the fifth set of content to generate a second level recommendation as the response for the request, wherein the second level recommendation may identify a second particular quantity of the fifth set of content, and wherein the second particular quantity may be greater than the first particular quantity.

As further shown in FIG. 6, process 600 may include performing one or more actions based on the response to the request (block 640). For example, the device (e.g., using computing resource 420, processor 520, memory 530, storage component 540, communication interface 570, and/or the like) may perform one or more actions based on the response to the request, as described above. In some implementations, performing the one or more actions may include providing, to the user device, a user interface that includes the response to the request; causing the response to be implemented for the user via the user device; or determining additional recommended content for the user based on the response to the request. In some implementations, performing the one or more actions may include determining whether the user acts on the response to the request; revising the response to the request based on feedback from the user regarding the response to the request; or retraining one or more of the one or more machine learning models based on the response to the request.

Process 600 may include additional implementations, such as any single implementation or any combination of implementations described below and/or in connection with one or more other processes described elsewhere herein.

In some implementations, process 600 may include receiving, from the user device, feedback associated with the response to the request; processing the feedback, with the one or more machine learning models, to determine a modified response to the request; and providing the modified response to the user device.

In some implementations, process 600 may include receiving, from the user device, data identifying preferred content selected by the user; processing the data identifying the preferred content, with the one or more machine learning models, to determine a modified response to the request; and performing one or more additional actions based on the modified response to the request.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

The foregoing disclosure provides illustration and description, but is not intended to be exhaustive or to limit the implementations to the precise form disclosed. Modifications and variations may be made in light of the above disclosure or may be acquired from practice of the implementations.

As used herein, the term “component” is intended to be broadly construed as hardware, firmware, or a combination of hardware and software.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device and from a user device, user data and a request associated with content,
wherein the user data identifies one or more of:
an action of a user of the user device,
a behavior of the user, or
a feature associated with the user;
receiving, by the device, constraint data identifying one or more constraints associated with the content;
processing the request, the user data, and the constraint data, with one or more machine learning models, to determine a response to the request,
wherein the response to the request includes a recommended set of the content for the user, and
wherein the one or more machine learning models have been trained based on one or more of:
historical requests associated with the content,
historical user data associated with other users of other user devices,
historical constraint data, or
historical content data associated with the content; and
performing, by the device, one or more actions based on the response to the request.

2. The method of claim 1, wherein performing the one or more actions comprises one or more of:
providing, to the user device, a user interface that includes the response to the request;
causing the response to be implemented for the user via the user device; or
determining additional recommended content for the user based on the response to the request.

3. The method of claim 1, wherein performing the one or more actions comprises one or more of:
determining whether the user acts on the response to the request;
revising the response to the request based on feedback from the user regarding the response to the request; or
retraining one or more of the one or more machine learning models based on the response to the request.

4. The method of claim 1, wherein, when the user is a prospective customer, processing the request, the user data, and the constraint data, with the one or more machine learning models, to determine the response to the request comprises:
processing particular content accessed by the user and user demographic data, with a first machine learning model of the one or more machine learning models, to identify a first set of content;
processing the first set of content and a frequency distribution of the content, with a second machine learning model of the one or more machine learning models, to identify a second set of content;
processing the second set of content and content genre data associated with the content, with a third machine learning model of the one or more machine learning models, to identify a third set of content; and
processing the third set of content and content popularity data associated with the content, with a fourth machine learning model of the one or more machine learning models, to identify a first level recommendation as the response for the request,
wherein the first level recommendation identifies a particular quantity of the third set of content.

5. The method of claim 1, wherein, when the user is a prospective customer and selected preferred content from the content, processing the request, the user data, and the constraint data, with the one or more machine learning models, to determine the response to the request comprises:
processing particular content accessed by the user and user demographic data, with a first machine learning model of the one or more machine learning models, to identify a first set of content;
processing the first set of content and a frequency distribution of the content, with a second machine learning model of the one or more machine learning models, to identify a second set of content;
processing the second set of content and conditional probabilities of the content, with a third machine learning model of the one or more machine learning models, to identify a third set of content;
processing the third set of content and content genre data associated with the content, with a fourth machine learning model of the one or more machine learning models, to identify a fourth set of content; and
assigning conditional probabilities to the fourth set of content to generate a first level recommendation as the response for the request,
wherein the first level recommendation identifies a first particular quantity of the fourth set of content.

6. The method of claim 5, further comprising:
processing the preferred content selected by the user and the user demographic data, with a fifth machine learning model of the one or more machine learning models, to identify a fifth set of content; and
assigning additional conditional probabilities to the fifth set of content to generate a second level recommendation as the response for the request,
wherein the second level recommendation identifies a second particular quantity of the fifth set of content, and
wherein the second particular quantity is greater than the first particular quantity.

7. The method of claim 1, wherein, when the user is a customer, processing the request, the user data, and the constraint data, with the one or more machine learning models, to determine the response to the request comprises:
processing particular content accessed by the user and customer data associated with the user, with a first machine learning model of the one or more machine learning models, to identify a first set of content;
processing the first set of content and content genre data associated with the content, with a second machine learning model of the one or more machine learning models, to identify a second set of content; and
processing the second set of content and content popularity data associated with the content, with a fourth machine learning model of the one or more machine learning models, to identify a first level recommendation as the response for the request,
wherein the first level recommendation identifies a particular quantity of the second set of content.

8. A device, comprising:
one or more processors configured to:
receive, from a user device, user data and a request associated with content,
wherein the user data identifies one or more of:
an action of a user of the user device,
a behavior of the user, or
a feature associated with the user;
receive constraint data identifying one or more constraints associated with the content;
process the request, the user data, and the constraint data, with one or more machine learning models, to determine a response to the request; and
perform one or more actions based on the response to the request,
wherein the one or more processors, when performing the one or more actions, are configured to one or more of:
provide, to the user device, a user interface that includes the response to the request,
cause the response to be implemented for the user via the user device,
determine additional recommended content for the user based on the response to the request,
determine whether the user acts on the response to the request,
revise the response to the request based on feedback from the user regarding the response to the request, or
retrain one or more of the one or more machine learning models based on the response to the request.

9. The device of claim 8, wherein, when the user is a customer and selected preferred content from the content, the one or more processors, when processing the request, the user data, and the constraint data, with the one or more machine learning models, to determine the response to the request, are configured to:
process particular content accessed by the user and customer data associated with the user, with a first machine learning model of the one or more machine learning models, to identify a first set of content;
process the first set of content and a frequency distribution of the content, with a second machine learning model of the one or more machine learning models, to identify a second set of content;
process the second set of content and content conditional probabilities of the content, with a third machine learning model of the one or more machine learning models, to identify a third set of content;
process the third set of content and content genre data associated with the content, with a fourth machine learning model of the one or more machine learning models, to identify a fourth set of content; and
assign conditional probabilities to the fourth set of content to generate a first level recommendation as the response for the request,
wherein the first level recommendation identifies a first particular quantity of the fourth set of content.

10. The device of claim 9, wherein the one or more processors are further configured to:
process the preferred content selected by the user and the customer data, with a fifth machine learning model of the one or more machine learning models, to identify a fifth set of content; and
assign additional conditional probabilities to the fifth set of content to generate a second level recommendation as the response for the request,
wherein the second level recommendation identifies a second particular quantity of the fifth set of content, and
wherein the second particular quantity is greater than the first particular quantity.

11. The device of claim 8, wherein the request includes data identifying particular content accessed by the user for a particular time period.

12. The device of claim 8, wherein the one or more processors are further configured to:
receive, from the user device, feedback associated with the response to the request;
process the feedback, with the one or more machine learning models, to determine a modified response to the request; and
provide the modified response to the user device.

13. The device of claim 8, wherein the content includes one or more of:
one or more linear programming channels,
video-on-demand content,
music content,
one or more games,
one or more widgets, or
one or more applications.

14. The device of claim 8, wherein the one or more processors are further configured to:
receive, from the user device, data identifying preferred content selected by the user;
process the data identifying the preferred content, with the one or more machine learning models, to determine a modified response to the request; and
perform one or more additional actions based on the modified response to the request.

15. A non-transitory computer-readable medium storing instructions, the instructions comprising:
one or more instructions that, when executed by one or more processors, cause the one or more processors to:
receive, from a user device, user data and a request associated with content,
wherein the user data identifies one or more of:
an action of a user of the user device,
a behavior of the user, or
a feature associated with the user;
receive constraint data identifying one or more constraints associated with the content;
process the request, the user data, and the constraint data, with one or more machine learning models, to determine a response to the request,
wherein the response to the request includes a recommended set of the content for the user, and
wherein the one or more machine learning models have been trained based on one or more of:
historical requests associated with the content,
historical user data associated with other users of other user devices,
historical constraint data, or
historical content data associated with the content;
perform one or more actions based on the response to the request;
receive, from the user device, feedback associated with the response to the request;
process the feedback, with the one or more machine learning models, to determine a modified response to the request; and
provide the modified response to the user device.

16. The non-transitory computer-readable medium of claim 15, wherein the one or more instructions, that cause the one or more processors to perform the one or more actions, cause the one or more processors to one or more of:
provide, to the user device, a user interface that includes the response to the request;
cause the response to be implemented for the user via the user device;
determine additional recommended content for the user based on the response to the request;
determine whether the user acts on the response to the request;
revise the response to the request based on feedback from the user regarding the response to the request; or
retrain one or more of the one or more machine learning models based on the response to the request.

17. The non-transitory computer-readable medium of claim 15, wherein, when the user is a prospective customer, the one or more instructions that cause the one or more processors to process the request, the user data, and the constraint data, with the one or more machine learning models, to determine the response to the request, cause the one or more processors to:
process particular content accessed by the user and user demographic data, with a first machine learning model of the one or more machine learning models, to identify a first set of content;
process the first set of content and a frequency distribution of the content, with a second machine learning model of the one or more machine learning models, to identify a second set of content;
process the second set of content and content genre data associated with the content, with a third machine learning model of the one or more machine learning models, to identify a third set of content; and
process the third set of content and content popularity data associated with the content, with a fourth machine learning model of the one or more machine learning models, to identify a first level recommendation as the response for the request,
wherein the first level recommendation identifies a particular quantity of the third set of content.

18. The non-transitory computer-readable medium of claim 15, wherein, when the user is a prospective customer and selected preferred content from the content, the one or more instructions that cause the one or more processors to process the request, the user data, and the constraint data, with the one or more machine learning models, to determine the response to the request, cause the one or more processors to:
process particular content accessed by the user and user demographic data, with a first machine learning model of the one or more machine learning models, to identify a first set of content;
process the first set of content and a frequency distribution of the content, with a second machine learning model of the one or more machine learning models, to identify a second set of content;
process the second set of content and conditional probabilities of the content, with a third machine learning model of the one or more machine learning models, to identify a third set of content;
process the third set of content and content genre data associated with the content, with a fourth machine learning model of the one or more machine learning models, to identify a fourth set of content; and
assign conditional probabilities to the fourth set of content to generate a first level recommendation as the response for the request,
wherein the first level recommendation identifies a first particular quantity of the fourth set of content.

19. The non-transitory computer-readable medium of claim 15, wherein, when the user is a customer, the one or more instructions that cause the one or more processors to process the request, the user data, and the constraint data, with the one or more machine learning models, to determine the response to the request, cause the one or more processors to:
process particular content accessed by the user and customer data associated with the user, with a first machine learning model of the one or more machine learning models, to identify a first set of content;
process the first set of content and content genre data associated with the content, with a second machine learning model of the one or more machine learning models, to identify a second set of content; and
process the second set of content and content popularity data associated with the content, with a fourth machine learning model of the one or more machine learning models, to identify a first level recommendation as the response for the request,
wherein the first level recommendation identifies a particular quantity of the second set of content.

20. The non-transitory computer-readable medium of claim 15, wherein, when the user is a customer and selected preferred content from the content, the one or more instructions that cause the one or more processors to process the request, the user data, and the constraint data, with the one or more machine learning models, to determine the response to the request, cause the one or more processors to:
process particular content accessed by the user and customer data associated with the user, with a first machine learning model of the one or more machine learning models, to identify a first set of content;
process the first set of content and a frequency distribution of the content, with a second machine learning model of the one or more machine learning models, to identify a second set of content;
process the second set of content and content conditional probabilities of the content, with a third machine learning model of the one or more machine learning models, to identify a third set of content;
process the third set of content and content genre data associated with the content, with a fourth machine learning model of the one or more machine learning models, to identify a fourth set of content; and
assign conditional probabilities to the fourth set of content to generate a first level recommendation as the response for the request,
wherein the first level recommendation identifies a first particular quantity of the fourth set of content.
